(19) United States
(12) Patent Application Publication
(10) Pub. No.: US 2008/0158138 A1
(43) Pub. Date: Jul. 3, 2008

(54) Liquid crystal display device and driving method thereof, and electronic device with the liquid crystal display device

(75) Inventors: Shunpei Yamazaki, Setagaya (JP); Atsushi Umezaki, Atsugi (JP)

Correspondence Address: ERIC ROBINSON, PMB 955, 21010 SOUTHBANK ST., POTOMAC FALLS, VA, 20165, US

(73) Assignee: Semiconductor Energy Laboratory Co., Ltd., Atsugi-shi (JP)

(21) Appl. No.: 12/003,428

(22) Filed: Dec. 26, 2007

(30) Foreign Application Priority Data
Dec. 27, 2006 (JP) 2006-352691

(51) Int. Cl. G09G 3/36; G02F 1/1333

(52) U.S. Cl. 345/102; 349/116

(57) ABSTRACT

It is an object of the present invention to provide a small-size and highly precise liquid crystal display device which has a function of adjusting luminance by using an optical sensor. Another object of the present invention is to provide a liquid crystal display with high image quality and low power consumption by function of adjusting luminance. A photoelectric conversion device is provided between a liquid crystal display panel and a backlight device. The photoelectric conversion device (also referred to as a photo IC) has a sensor for detecting light and the driver portion for the driving the sensor. The intensity of light from the backlight device can be controlled by detecting the external light which enters the liquid crystal panel and affects the display with the sensor, and by feeding back the data to the backlight device.

### BACKGROUND OF THE PRESENT INVENTION

1. Field of the present invention

The present invention relates to a liquid crystal display device and driving method thereof, in particular, a liquid crystal display device having a photoelectric conversion device. Further, the present invention relates to an electronic device using such a liquid crystal display device.

2. Description of the Related Art

In general, photoelectric conversion devices for detecting electromagnetic waves are widely known. For example, a photoelectric conversion device having sensitivity from ultraviolet rays to infrared rays is collectively called an optical sensor. Among the optical sensors, one having sensitivity in a visible light region of a wavelength of 400 to 700 nm is referred to as a visible optical sensor, which is variously used for a device that needs luminance adjustment or on-off control depending on the environment of human life.

For instance, an optical sensor is used as a luminance-controlling device for controlling the luminance of a backlight device of a liquid crystal display device. (see Reference 1: Japanese Published Patent Application No. H10-222129)

### SUMMARY OF THE PRESENT INVENTION

However, in Reference 1, since an optical sensor is provided on the back face of the backlight device, a liquid crystal display device becomes larger. Although the luminance of the backlight device can be detected, brightness of the outside of the display screen side cannot be detected.

In view of the foregoing problem, it is an object of the present invention to provide a small-size and highly precise liquid crystal display device which has a function of adjusting luminance by using an optical sensor. Another object of the present invention is to provide a liquid crystal display device with high image quality and low power consumption by the function of adjusting luminance.

The present invention is characterized in that a photoelectric conversion device is provided between a liquid crystal display panel and a backlight device in a liquid crystal display device. The photoelectric conversion device of the present invention (also referred to as a photo IC) has a sensor for detecting the light and a driver portion for the driving the sensor. The intensity of the light from the backlight device can be controlled by the sensor detecting the external light which enters the liquid crystal panel from the exterior and affects displaying, and by feeding back the data to the backlight device. Thus, variations of display luminance of the display portion can be prevented and high quality display can be achieved. Further, since the external light can be used effectively, excessive drive of the backlight device can be prevented and the liquid crystal display device with high reliability and low power consumption can be achieved.

In the present invention, a photoelectric conversion device can be provided between a liquid crystal display panel and a backlight device. As long as the external light transmitted through a display panel is detected with a sensor, the photoelectric conversion device can be provided in the backlight device. The backlight device may have an optical sheet including a light guide plate, a reflector plate, a diffuser panel and/or the like in addition to a light source, and the photoelectric conversion device is provided over the optical sheet.

When the photoelectric conversion device detects the light, by the backlight device turning off, the photoelectric conversion device can detect only the external light without detecting the light from the backlight device.

An aspect of a liquid crystal display device of the present invention is a liquid crystal display device including a photoelectric conversion device, a liquid crystal panel provided with a pixel portion, and a backlight device. The photoelectric conversion device is provided between the backlight device and the pixel portion of the liquid crystal panel.

Another aspect of a liquid crystal display device of the present invention is a liquid crystal display device including a photoelectric conversion device having a sensor and a driver portion, a liquid crystal panel having a pixel portion and a peripheral portion of the pixel portion (hereinafter also referred to as a pixel portion periphery), and a backlight device. The sensor is provided between the backlight device and the pixel portion of the liquid crystal panel. The driver portion is provided between the backlight device and the pixel portion periphery of the liquid crystal panel.

Another aspect of a liquid crystal display device of the present invention is a liquid crystal display device including a photoelectric conversion device having a sensor and a driver portion, a liquid crystal panel provided with a pixel portion, and a backlight device. The pixel portion of the liquid crystal panel includes a light-transmitting region and a light-shielding region. The sensor is provided between the backlight device and the light-transmitting region of the pixel portion of the liquid crystal panel.

Another aspect of a liquid crystal display device of the present invention is a liquid crystal display device including a photoelectric conversion device including a sensor and a driver portion, a liquid crystal panel provided with a pixel portion, and a backlight device. The pixel portion of the liquid crystal panel includes a light-transmitting region and a light-shielding region. The sensor is provided between the backlight device and the light-transmitting region of the pixel portion of the liquid crystal panel. The driver portion is provided between the backlight device and the light-shielding region of the pixel portion of the liquid crystal panel.

Another aspect of a liquid crystal display device of the present invention is a liquid crystal display device including a photoelectric conversion device including a sensor and a driver portion, a liquid crystal panel provided with a pixel portion, and a backlight device. The pixel portion of the liquid crystal panel includes a light-transmitting region and a reflective region. The sensor is provided between the backlight device and the light-transmitting region of the pixel portion of the backlight device.

Another aspect of a liquid crystal display device of the present invention is a liquid crystal display device including a photoelectric conversion device including a sensor and a driver portion, a liquid crystal panel provided with a pixel portion, and a backlight device. The pixel portion of the liquid crystal panel includes a light-transmitting region and a reflective region. The sensor is provided between the backlight device and the light-transmitting region of the pixel portion of the backlight device. The driver portion is provided between the backlight device and the reflective region of the pixel portion of the liquid crystal panel.

In the foregoing structure, wirings, transistors, black matrixes, and the like can be provided in the light-shielding region. Further, a first pixel electrode having a light-transmitting property is provided in the light-transmitting region, and a second pixel electrode having reflective property is provided in the reflective region.

Note that various types of switches can be used as a switch described in this documents (specification, claims, drawings, and the like). An electrical switch, a mechanical switch, and the like are given as examples. That is, any element can be used as long as it can control a current flow, without limiting to a particular element. For example, a transistor (e.g., a bipolar transistor or a MOS transistor), a diode (e.g., a PN diode, a PIN diode, a Schottky diode, an MIM (Metal Insulator Metal) diode, an MIS (Metal Insulator Semiconductor) diode, or a diode-connected transistor), a thyristor, or the like can be used as a switch. Alternatively, a logic circuit in which such elements are combined can be used as a switch.

In the case of using a transistor as a switch, polarity (a conductivity type) of the transistor is not particularly limited because it operates just as a switch. However, a transistor of polarity with a smaller off-current is preferably used when an off-current should be small. A transistor provided with an LDD region, a transistor with a multi-gate structure, and the like are given as examples of a transistor with a smaller off-current. In addition, it is preferable that an N-channel transistor be used when a potential of a source terminal of the transistor which is operated as a switch is closer to a potential of a low-potential-side power supply (e.g., Vss, GND, or 0 V), while a p-channel transistor be used when the potential of the source terminal is closer to a potential of a high-potential-side power supply (e.g., Vdd). This is because the absolute value of gate-source voltage can be increased when the potential of the source terminal of an N-channel transistor is closer to a potential of a low-potential-side power supply and when the potential of the source terminal of a p-channel transistor is closer to a potential of a high-potential-side power supply so that the transistors can more easily operate as a switch. This is also because the transistors hardly conduct a source follower operation, so that reduction in output voltage hardly occurs.

Note that a CMOS switch may be employed as a switch by using both N-channel and p-channel transistors. By employing a CMOS switch, the transistor can be more functional as a switch because a current can flow when either the p-channel transistor or the N-channel transistor is turned on. For example, a voltage can be appropriately output regardless of whether a voltage of an input signal to the switch is high or low. In addition, since a voltage amplitude value of a signal for turning on or off the switch can be made small, power consumption can be reduced.

Note that when a transistor is employed as a switch, the switch includes an input terminal (one of a source terminal and a drain terminal), an output terminal (the other of the source terminal and the drain terminal), and a terminal for controlling electrical conduction (a gate terminal). On the other hand, when a diode is employed as a switch, the switch does not have a terminal for controlling electrical conduction in some cases. Therefore, the number of wirings for controlling terminals can be more reduced when a diode is used as a switch than the case of using a transistor.

Note that when it is explicitly described that “A and B are connected” in this documents (specification, claims, drawings, and the like), the case where A and B are electrically connected, the case where A and B are functionally connected, and the case where A and B are directly connected are included therein. Here, each of A and B is an object (e.g., a device, an element, a circuit, a wiring, an electrode, a terminal, a conductive film, or a layer). Accordingly, in structures disclosed in this documents (specification, claims, drawings, and the like), connections other than the connection described in this specification and illustrated in the drawings are also included, without limitations to predetermined connections, and such connections described in this specification and illustrated in the drawings.

For example, in the case where A and B are electrically connected, one or more elements which enable electrical connection of A and B (e.g., a switch, a transistor, a capacitor, an inductor, a resistor, and/or a diode) may be provided between A and B. In addition, in the case where A and B are functionally connected, one or more circuits which enable functional connection of A and B (e.g., a logic circuit such as an inverter, a NAND circuit, or a NOR circuit, a signal converter circuit such as a DA converter circuit, an AD converter circuit, or a gamma correction circuit, a potential level converter circuit such as a power supply circuit (e.g., a boosting circuit or a voltage lower control circuit) or a level shifter circuit for changing a potential level of a signal, a voltage source, a current source, a switching circuit, or an amplifier circuit such as a circuit which can increase signal amplitude, the amount of current, or the like (e.g., an operational amplifier, a differential amplifier circuit, a source follower circuit, or a buffer circuit), a signal generating circuit, a memory circuit, and/or a control circuit) may be provided between A and B. Alternatively, in the case where A and B are directly connected, A and B may be directly connected without another element or another circuit interposed therebetween.

Note that when it is explicitly described that “A and B are directly connected”, the case where A and B are directly connected (i.e., the case where A and B are connected without another element or another circuit interposed therebetween) and the case where A and B are electrically connected (i.e., the case where A and B are connected with another element or another circuit interposed therebetween) are included therein.

Note that when it is explicitly described that “A and B are electrically connected”, the case where A and B are electrically connected (i.e., the case where A and B are connected with another element or another circuit interposed therebetween), the case where A and B are functionally connected (i.e., the case where A and B are functionally connected with another circuit interposed therebetween), and the case where A and B are directly connected (i.e., the case where A and B are connected without another element or another circuit interposed therebetween) are included therein. That is, when it is explicitly described that “A and B are electrically connected”, the description is the same as the case where it is explicitly only described that “A and B are connected”.

Note that a display element, a display device which is a device having a display element, a light-emitting element, and a light-emitting device which is a device having a light-emitting element can employ various types and can include various elements. For example, as a display element, a display device, a light-emitting element, or a light-emitting device, a display medium whose contrast, luminance, reflectivity, transmittivity, or the like changes by an electromagnetic action, such as an EL element (e.g., an organic EL element, an inorganic EL element, or an EL element including both organic and inorganic materials), an electron-emissive element, a liquid crystal element, electronic ink, an electrophoresis element, a grating light valve (GLV), a plasma display panel (PDP), a digital micromirror device (DMD), a piezoelectric ceramic display, or a carbon nanotube can be employed. Note that display devices using an EL element include an EL display; display devices using an electron-emissive element include a field emission display (FED), an SED-type flat panel display (SED: Surface-conduction Electron-emitter Display), and the like; display devices using a liquid crystal element include a liquid crystal display (e.g., a transmissive liquid crystal display, a semi-transmissive liquid crystal display, a reflective liquid crystal display, a direct-view liquid crystal display, or a projection liquid crystal display); and display devices using electronic ink or an electrophoresis element include electronic paper.

Note that various types of transistors can be employed without limitations to a particular type as a transistor described in this documents (specification, claims, drawings, and the like). For example, thin film transistors (TFT) including a non-single crystalline semiconductor film typified by amorphous silicon, polycrystalline silicon, microcrystal (also referred to as semi-amorphous) silicon, or the like can be employed. In the case of using such TFFs, there are various advantages. For example, since TFTs can be formed at lower temperature than those using single crystalline silicon, the manufacturing cost can be reduced and a manufacturing device can be made larger. Since the manufacturing device can be made larger, the TFTs can be formed using a large substrate. Therefore, since a large number of display devices can be formed at the same time, they can be formed at low cost. In addition, because the manufacturing temperature is low, a substrate having low heat resistance can be used. Thus, transistors can be formed using a light-transmitting substrate. Further, transmission of light in a display element can be controlled by using the transistors formed using the light-transmitting substrate. Furthermore, a part of a film which forms a transistor can transmit light because film thickness of the transistor is thin. Accordingly, an aperture ratio can be improved.

By using a catalyst (e.g., nickel) in the case of forming polycrystalline silicon, crystallinity can be more improved and a transistor having excellent electric characteristics can be formed. Accordingly, a gate driver circuit (e.g., a scan line driver circuit), a source driver circuit (e.g., a signal line driver circuit), and a signal processing circuit (e.g., a signal generation circuit, a gamma correction circuit, or a DA converter circuit) can be formed over the same substrate.

In addition, by using a catalyst (e.g., nickel) in the case of forming microcrystal silicon, crystallinity can be more improved and a transistor having excellent electric characteristics can be formed. At this time, crystallinity can be improved by performing heat treatment without using laser irradiation. Accordingly, a gate driver circuit (e.g., a scan line driver circuit) and a part of a source driver circuit (e.g., an analog switch) can be formed on the same substrate. In addition, in the case of not using a laser for crystallization, crystallinity unevenness (mura) of silicon can be suppressed. Therefore, an image having high image quality can be displayed.

Note that polycrystalline silicon and microcrystal silicon can be formed without using a catalyst (such as nickel).

In addition, a transistor can be formed by using a semiconductor substrate, an SOI substrate, or the like. Therefore, a transistor with few variations in characteristics, sizes, shapes, or the like, with high current supply capacity, and with a small size can be formed. By using such a transistor, power consumption of a circuit can be reduced or a circuit can be highly integrated.

In addition, a transistor including a compound semiconductor or an oxide semiconductor such as ZnO, a-InGaZnO, SiGe, GaAs, IZO, ITO, or SnO, and a thin film transistor or the like obtained by thinning such a compound semiconductor or a oxide semiconductor can be used. Therefore, manufacturing temperature can be lowered and for example, such a transistor can be formed at room temperature. Accordingly, the transistor can be formed directly on a substrate having low heat resistance such as a plastic substrate or a film substrate. Note that such a compound semiconductor or an oxide semiconductor can be used for not only a channel portion of a transistor but also in other applications. For example, such a compound semiconductor or an oxide semiconductor can be used for a resistor, a pixel electrode, or a light-transmitting electrode. Further, since such an element can be formed at the same time as the transistor, the cost can be reduced.

Transistors or the like formed by using an inkjet method or a printing method can also be used. Accordingly, transistors can be formed at room temperature, can be formed at a low vacuum, or can be formed using a large substrate. In addition, since transistors can be formed without using a mask (a reticle), layout of the transistors can be easily changed. Further, since it is not necessary to use a resist, the material cost is reduced and the number of steps can be reduced. Furthermore, since a film is formed only in a necessary portion, a material is not wasted compared with a manufacturing method in which etching is performed after a film is formed over the entire surface, so that the cost can be reduced.

Further, transistors or the like including an organic semiconductor or a carbon nanotube can be used. Accordingly, such transistors can be formed using a bendable or flexible substrate. Therefore, such transistors can resist a shock.

In addition, various types of transistors can be used. For example, a MOS transistor, a junction transistor, a bipolar transistor, or the like can be employed as a transistor described in this documents (specification, claims, drawings, and the like). Since a MOS transistor has a small size, a large number of transistors can be mounted. The use of a bipolar transistor can allow a large current to flow, thereby operating a circuit at high speed.

Further, a MOS translstol, a bipolar transistor and/or the like may be mixed on a one substrate. Thus, low power consumption, reduction in size and high speed operation can be achieved.

Furthermore, various transistors other than the above-described types of transistors can be used.

Moreover, various types of substrates that a transistor is formed can be used, and the type of a substrate is not limited to a particular type. For example, a single crystalline substrate, an SOI substrate, a glass substrate, a quartz substrate, a plastic substrate, a paper substrate, a cellophane substrate, a stone substrate, a wood substrate, a cloth substrate (including a natural fiber (e.g., silk, cotton, or hemp), a synthetic fiber (e.g., nylon, polyurethane, or polyester), a regenerated fiber (e.g., acetate, cupra, rayon, or regenerated polyester), or the like), a leather substrate, a rubber substrate, a stainless steel substrate, a substrate including a stainless steel foil, or the like can be used as a substrate that a transistor is formed. Alternatively, a skin (e.g., cuticle or corium) or hypodermal tissue of an animal such as a human being can be used as a substrate. In addition, transistors may be formed using a substrate, and then, the transistors may be transferred to another substrate. As a substrate to which the transistors are transferred, a single crystalline substrate, an SOI substrate, a glass substrate, a quartz substrate, a plastic substrate, a paper substrate, a cellophane substrate, a stone substrate, a wood substrate, a cloth substrate (including a natural fiber (e.g., silk, cotton, or hemp), a synthetic fiber (e.g., nylon, polyurethane, or polyester), a regenerated fiber (e.g., acetate, cupra, rayon, or regenerated polyester), or the like), a leather substrate, a rubber substrate, a stainless steel substrate, a substrate including a stainless steel foil, or the like can be used. Alternatively, a skin (e.g., cuticle or corium) or hypodermal tissue of an animal such as a human being can be used. In addition, transistors may be formed using a substrate, and then, the substrate may be thinned by polishing. As a substrate which is polished, a single crystalline substrate, an SOI substrate, a glass substrate, a quartz substrate, a plastic substrate, a paper substrate, a cellophane substrate, a stone substrate, a wood substrate, a cloth substrate (including a natural fiber (e.g., silk, cotton, or hemp), a synthetic fiber (e.g., nylon, polyurethane, or polyester), a regenerated fiber (e.g., acetate, cupra, rayon, or regenerated polyester), or the like), a leather substrate, a rubber substrate, a stainless steel substrate, a substrate including a stainless steel foil, or the like can be used. Alternatively, a skin (e.g., cuticle or corium) or hypodermal tissue of an animal such as a human being can be used. By using such a substrate, transistors with excellent properties or transistors with low power consumption can be formed, a device with high durability or high heat resistance can be formed, or reduction in weight or thinning can be achieved.

A structure of a transistor can be various forms without limiting to a particular structure. For example, a multi-gate structure having two or more gate electrodes may be used. When the multi-gate structure is used, a structure where a plurality of transistors are connected in series is provided because channel regions are connected in series. By using the multi-gate structure, an off-current can be reduced or the withstand voltage of transistors can be increased (improvement in reliability). Alternatively, by using the multi-gate structure, a drain-source current does not fluctuate very much even if a drain-source voltage fluctuates when the transistor operates in a saturation region, so that a slope of voltage-current characteristics can be flat. By utilizing the characteristics that the slope of the voltage-current characteristics is flat, an ideal current source circuit or an active load having an extremely high resistance value can be provided. Accordingly, a differential circuit or a current mirror circuit having excellent properties can be provided. In addition, a structure where gate electrodes are formed above and below a channel may be used. By using the structure where gate electrodes are formed above and below the channel, a channel region is enlarged, so that the amount of current flowing therethrough can be increased. In addition, by using the structure where gate electrodes are formed above and below the channel, a depletion layer can be easily formed to decrease a subthreshold swing (S value). When the gate electrodes are formed above and below the channel, a structure where a plurality of transistors are connected in parallel is provided.

Alternatively, a structure where a gate electrode is formed above a channel, a structure where a gate electrode is formed below a channel can be employed. Also, a staggered structure, an inversely staggered structure, a structure where a channel region is divided into a plurality of regions, a structure where channel regions are connected in parallel or a structure where channel regions are connected in series can be employed. In addition, a source electrode or a drain electrode may overlap with a channel region (or part of it). By using the structure where the source electrode or the drain electrode may overlap with the channel region (or part of it), unstable operation due to electric charges accumulated in part of the channel region can be prevented. Alternatively, an LDD region may be provided. By providing the LDD region, an off-current can be reduced or the withstand voltage of transistors can be increased to improve reliability. Alternatively, by providing the LDD region, a drain-source current does not fluctuate so much even if a drain-source voltage fluctuates when a transistor operates in the saturation region, so that a slope of voltage-current characteristics can be flat.

Various types of transistors can be used as a transistor described in this documents (specification, claims, drawings, and the like) and transistors can be formed using various types of substrates. Accordingly, all of the circuits which are necessary to realize a desired function can be formed using the same substrate. For example, all of the circuits which are necessary to realize a desired function can be formed using a glass substrate, a plastic substrate, a single crystalline substrate, an SOI substrate, or any other substrate. When all of the circuits which are necessary to realize a desired function are formed using the same substrate, the number of component parts can be reduced to cut the cost or the number of connections between circuit components can be reduced to improve reliability. Alternatively, part of the circuits which are necessary to realize a desired function may be formed using one substrate and another part of the circuits which are necessary to realize a desired function may be formed using another substrate. That is, not all of the circuits which are necessary to realize a desired function are required to be formed using the same substrate. For example, part of the circuits which are necessary to realize a desired function may be formed with transistors using a glass substrate and another part of the circuits which are necessary to realize the desired function may be formed using a single crystalline substrate, so that an IC chip formed from transistors using the single crystalline substrate may be connected to the glass substrate by COG (Chip On Glass) and the IC chip may be provided on the glass substrate. Alternatively, the IC chip may be connected to the glass substrate by TAB (Tape Automated Bonding) or a printed wiring board. When part of the circuits are formed using the same substrate in this manner, the number of the component parts can be reduced to cut the cost or the number of connections between the circuit components can be reduced to improve reliability. Further, since circuits in a portion with a high driving voltage or a portion with high driving frequency consume large power, the circuits in such portions are not formed on the same substrate, and instead, the circuits are formed using e.g., a single crystalline substrate and an IC chip formed from the circuits is used, which leads to prevention of increase in power consumption.

Note that one pixel corresponds to a minimum unit of an image in this documents (specification, claims, drawings, and the like). Accordingly, in the case of a full color display device having color elements of R (Red), G (Green), and B (Blue), one pixel is formed of a dot of an R color element, a dot of a G color element, and a dot of a B color element. Note that the color elements are not limited to three colors, and color elements of more than three colors may be used or a color other than RGB may be added. For example, RGBW (W corresponds to white) may be used by adding white. Alternatively, RGB plus one or more colors of yellow, cyan, magenta, emerald green, vermilion, and the like may be used. Alternatively, a color similar to at least one of R, G, and B may be added to RGB. For example, R, G, B1, and B2 may be used. Although both B1 and B2 are blue, they have slightly different frequency. Similarly, R1, R2, G, and B may be used. By using such color elements, display which is closer to the real object can be performed or power consumption can be reduced. Note that a plurality of dots which is the same color of color elements may be provided in one pixel. At that time, the plurality of color elements may have different size of region which serves for display. Additionally, by controlling a plurality of dots which is the same color of color elements, gray scales can be expressed. This is called as an area ratio gray scale method. Alternatively, using a plurality of dots which have the same color of color elements, signals supplied to the plurality of dots may be slightly varied to widen a viewing angle. That is, potentials of pixel electrodes included in a plurality of color elements of the same color may be different from each other. Accordingly, a voltage applied to liquid crystal molecules are varied depending on the pixel electrodes. Therefore, the viewing angles can be widened.

Note that in these documents (specification, claims, drawings, and the like), pixels are provided (arranged) in matrix in some cases. Here, description that pixels are provided (arranged) in matrix includes the case where the pixels are arranged in a straight line and the case where the pixels are arranged in a jagged line, in a longitudinal direction or a lateral direction. Therefore, in the case of performing full color display with three color elements (e.g., RGB), a case where pixels are arranged in stripes and a case where dots of the three color elements are arranged in a delta pattern are included. Additionally, a case which dots of the three color elements are provided in Bayer arrangement are also included. Note that the color elements are not limited to three colors, and more than three color elements may be employed. RGBW (W corresponds to white), RGB plus one or more of yellow, cyan, magenta, and/or the like is given as an example. Further, the sizes of display regions may be different between respective dots of color elements. Thus, power consumption can be reduced and the life of a display element can be prolonged.

Furthermore, in this documents (specification, claims, drawings, and the like), an active matrix method in which an active element is included in a pixel or a passive matrix method in which an active element is not included in a pixel can be used.

In the active matrix method, as an active element (a non-linear element), not only a transistor but also various active elements (non-linear elements) can be used. For example, an MIM (Metal Insulator Metal), a TFD (Thin Film Diode), or the like can also be used. Since such an element needs less number of manufacturing steps, the manufacturing cost can be reduced or a yield can be improved. Further, since the size of such an element is small, an aperture ratio can be improved, so that power consumption can be reduced and higher luminance can be achieved.

As a method other than the active matrix method, the passive matrix method in which an active element (a non-linear element) is not used can also be used. Since an active element (a non-linear element) is not used, the manufacturing steps are fewer, so that the manufacturing cost can be reduced or the yield can be improved. Further, since an active element (a non-linear element) is not used, the aperture ratio can be improved, so that power consumption can be reduced and high luminance can be achieved.

Note that a transistor is an element having at least three terminals of a gate, a drain, and a source. The transistor has a channel region between a drain region and a source region, and a current can flow through the drain region, the channel region, and the source region. Here, since the source and the drain of the transistor may change depending on the structure, the operating condition, etc., of the transistor, it is difficult to define which is a source or a drain. Therefore, in this specification (including description, scope of claims, drawings and the like), a region functioning as a source and a drain is not called the source or the drain in some cases. In such a case, for example, one of the source and the drain may be described as a first terminal and the other thereof may be described as a second terminal. Alternatively, one of the source and the drain may be described as a first electrode and the other thereof may be described as a second electrode. Further alternatively, one of the source and the drain may be described as a source region and the other thereof may be called a drain region.

Note also that a transistor may be an element having at least three terminals of a base, an emitter, and a collector. In this case also, one of the emitter and the collector may be similarly called a first terminal and the other terminal may be called a second terminal.

A gate corresponds to the whole or part of a gate electrode and a gate wiring (also called a gate line, a gate signal line, a scan line, a scan signal line, or the like). A gate electrode corresponds to part of a conductive film which overlaps with a semiconductor which forms a channel region with a gate insulating film interposed therebetween. Note that part of the gate electrode overlaps with an LDD (Lightly Doped Drain) region, or the source region or the drain region with the gate insulating film interposed therebetween in some cases. A gate wiring corresponds to a wiring for connecting a gate electrode of each transistor to each other, a wiring for connecting a gate electrode of each pixel to each other, or a wiring for connecting a gate electrode to another wiring.

However, there is a portion (a region, a conductive film, a wiring, or the like) which functions as both a gate electrode and a gate wiring. Such a portion (a region, a conductive film, a wiring, or the like) may be called either a gate electrode or a gate wiring. That is, there is a region where a gate electrode and a gate wiring cannot be clearly distinguished from each other. For example, in the case where a channel region overlaps with part of an extended gate wiring, the overlapped portion (region, conductive film, wiring, or the like) functions as both a gate wiring and a gate electrode. Accordingly, such a portion (a region, a conductive film, a wiring, or the like) may be called either a gate electrode or a gate wiring.

In addition, a portion (a region, a conductive film, a wiring, or the like) which is formed of the same material as a gate electrode, forms the same island as the gate electrode to be connected to the gate electrode may also be called a gate electrode. Similarly, a portion (a region, a conductive film, a wiring, or the like) which is formed of the same material as a gate wiring, forms the same island as the gate wiring to be connected to the gate wiring may also be called a gate wiring. In a strict sense, such a portion (a region, a conductive film, a wiring, or the like) does not overlap with a channel region or does not have a function of connecting a gate electrode to another gate electrode in some cases. However, there is a portion (a region, a conductive film, a wiring, or the like) which is formed of the same material as a gate electrode or a gate wiring, forms the same island as the gate electrode or the gate wiring to be connected to the gate electrode or the gate wiring because of the accuracy of the location in the manufacturing process. Thus, such a portion (a region, a conductive film, a wiring, or the like) may also be called either a gate electrode or a gate wiring.

In a multi-gate transistor, for example, a gate electrode is often connected to another gate electrode by using a conductive film which is formed of the same material as the gate electrodes. Since such a portion (a region, a conductive film, a wiring, or the like) is a portion (a region, a conductive film, a wiring, or the like) for connecting the gate electrode to the another gate electrode, it may be called a gate wiring, but it may also be called a gate electrode because a multi-gate transistor can be considered as one transistor. That is, a portion (a region, a conductive film, a wiring, or the like) which is formed of the same material as a gate electrode or a gate wiring, forms the same island as the gate electrode or the gate wiring to be connected to the gate electrode or the gate wiring may be called either a gate electrode or a gate wiring. In addition, for example, part of a conductive film which connects a gate electrode and a gate wiring and is formed from a different material from the gate electrode and the gate wiring may also be called either a gate electrode or a gate wiring.

Note that a gate terminal corresponds to part of a portion (a region, a conductive film, a wiring, or the like) of a gate electrode or a portion (a region, a conductive film, a wiring, or the like) which is electrically connected to the gate electrode.

Note that when a wiring is called a gate wiring, a gate line, a gate signal line, a scan line, or a scan signal line, there is a case in which a gate of a transistor is not connected to a wiring. In this case, the gate wiring, the gate line, the gate signal line, the scan line, or the scan signal line corresponds to a wiring formed in the same layer as the gate of the transistor, a wiring formed of the same material of the gate of the transistor, or a wiring formed at the same time as the gate of the transistor in some cases. As examples, a wiring for storage capacitor, a power supply line, a reference potential supply line, and the like can be given.

Note also that a source corresponds to the whole or part of a source region, a source electrode, and a source wiring (also called a source line, a source signal line, a data line, a data signal line, or the like). A source region corresponds to a semiconductor region containing a large amount of p-type impurities (e.g., boron or gallium) or n-type impurities (e.g., phosphorus or arsenic). Accordingly, a region containing a small amount of p-type impurities or n-type impurities, namely, an LDD (Lightly Doped Drain) region is not included in the source region. A source electrode is part of a conductive layer formed of a material different from that of a source region, and electrically connected to the source region. However, there is a case where a source electrode and a source region are collectively called a source electrode. A source wiring is a wiring for connecting source electrodes of transistors to each other, a wiring for connecting source electrodes of pixels to each other, or a wiring for connecting a source electrode to another wiring.

However, there is a portion (a region, a conductive film, a wiring, or the like) functioning as both a source electrode and a source wiring. Such a portion (a region, a conductive film, a wiring, or the like) may be called either a source electrode or a source wiring. That is, there is a region where a source electrode and a source wiring cannot be clearly distinguished from each other. For example, in a case where a source region overlaps with part of an extended source wiring, the overlapped portion (region, conductive film, wiring, or the like) functions as both a source wiring and a source electrode. Accordingly, such a portion (a region, a conductive film, a wiring, or the like) may be called either a source electrode or a source wiring.

In addition, a portion (a region, a conductive film, a wiring, or the like) which is formed of the same material as a source electrode, forms the same island as the source electrode to be connected to the source electrode, or a portion (a region, a conductive film, a wiring, or the like) which connects a source electrode and another source electrode may also be called a source electrode. Further, a portion which overlaps with a source region may be called a source electrode. Similarly, a portion which is formed of the same material as a source wiring, forms the same island as the source wiring to be connected to the source wiring may also be called a source wiring. In a strict sense, such a portion (a region, a conductive film, a wiring, or the like) does not have a function of connecting a source electrode to another source electrode in some cases. However, there is a portion (a region, a conductive film, a wiring, or the like) which is formed of the same material as a source electrode or a source wiring, and is connected to the source electrode or the source wiring because of the location accuracy in the manufacturing process. Thus, such a portion (a region, a conductive film, a wiring, or the like) may also be called either a source electrode or a source wiring.

In addition, for example, part of a conductive film which connects a source electrode and a source wiring and is formed of a material different from that of the source electrode or the source wiring may be called either a source electrode or a source wiring.

Note that a source terminal corresponds to part of a source region, a source electrode, or a portion (a region, a conductive film, a wiring, or the like) which is electrically connected to the source electrode.

Note that when a wiring is called a source wiring, a source line, a source signal line, a data line, or a data signal line, there is a case in which a source (a drain) of a transistor is not connected to a wiring. In this case, the source wiring, the source line, the source signal line, the data line, or the data signal line corresponds to a wiring formed in the same layer as the source (the drain) of the transistor, a wiring formed of the same material of the source (the drain) of the transistor, or a wiring formed at the same time as the source (the drain) of the transistor in some cases. As examples, a wiring for storage capacitor, a power supply line, a reference potential supply line, and the like can be given.

Note also that the same can be applied to a drain.

Note also inat a semiconductor device corresponds to a device having a circuit including a semiconductor element (e.g., a transistor, a diode, or thyristor). The semiconductor device may be general devices that can function by utilizing semiconductor characteristics. Furthermore, devices including a semiconductor material are also referred to as semiconductor devices.

Note also that a display element corresponds to an optical modulation element, a liquid crystal element, a light-emitting element, an EL element (an organic EL element, an inorganic EL element, or an EL element including organic and inorganic materials), an electron-emissive element, an electrophoresis element, a discharging element, a light-reflecting element, a light diffraction element, a digital micromirror device (DMD), or the like. Note that the present invention is not limited to these examples.

In addition, a display device corresponds to a device having a display element. Note that a display device may include a plurality of pixels including a display element. In addition, a display device may include a peripheral driver circuit for driving the plurality of pixels. The peripheral driver circuit for driving the plurality of pixels may be formed on the same substrate as the plurality of pixels. In addition, a display device may also include a peripheral driver circuit provided over a substrate by wire bonding or bump bonding, namely, an IC chip connected by chip on glass (COG) or an IC chip connected by TAB or the like. Further, a display device may include a flexible printed circuit (FPC) to which an IC chip, a resistor, a capacitor, an inductor, a transistor, or the like is attached. Note that a display device may include a printed wiring board (PWB) which is connected through a flexible printed circuit (FPC) and to which an IC chip, a resistor, a capacitor, an inductor, a transistor, or the like is attached. A display device may also include an optical sheet such as a polarizing plate or a retardation plate. A display device may also include a lighting device, a housing, an audio input and output device, an optical sensor, and the like. Here, a lighting device such as a backlight device may include a light guide plate, a prism sheet, a diffusion sheet, a reflective sheet, a light source (e.g., an LED or a cold cathode tube), a cooling device (e.g., a water cooling device or an air cooling uevice), or the like.

Moreover, a lighting device corresponds to a device having a light guide plate, a prism sheet, a diffusion sheet, a reflective sheet, or a light source (e.g., an LED, a cold cathode tube, or a hot cathode tube), a cooling device, or the like.

In addition, a light-emitting device corresponds to a device having e.g., a light-emitting element. When a light-emitting element is used as a display element, a light-emitting device is a typical example of a display device.

Note that a reflective device corresponds to a device having a light-reflecting element, a light-diffraction element, a light-reflecting electrode, or the like.

A liquid crystal display device corresponds to a display device including a liquid crystal element. Liquid crystal display devices include a direct-view liquid crystal display, a projection liquid crystal display, a transmissive liquid crystal display, a reflective liquid crystal display, a semi-transmissive liquid crystal display, and the like.

Note also that a driving device corresponds to a device having a semiconductor element, an electric circuit, an electronic circuit and/or the like. For example, a transistor which controls input of a signal from a source signal line to a pixel (also called a selection transistor, a switching transistor, or the like), a transistor which supplies a voltage or current to a pixel electrode, a transistor which supplies a voltage or current to a light-emitting element, and the like are examples of the driving device. A circuit which supplies a signal to a gate signal line (also called a gate driver, a gate line driver circuit, or the like), a circuit which supplies a signal to a source signal line (also called a source driver, a source line driver circuit, or the like) is also examples of the driving device.

Note that a display device, a semiconductor device, a lighting device, a cooling device, a light-emitting device, a reflective device, a driving device, and the like are provided together in some cases. For example, a display device includes a semiconductor device and a light-emitting device in some cases. Alternatively, a semiconductor device includes a display device and a driving device in some cases.

When “B is formed on A” or “B is formed over A” is explicitly described in this documents (specification, claims, drawings, and the like), it does not necessarily mean that B is formed in direct contact with A. The description includes a case where A and B are not in direct contact with each other, i.e., a case where another object is interposed between A and B. Here, each of A and B corresponds to an object (e.g., a device, an element, a circuit, a wiring, an electrode, a terminal, a conductive film, or a layer).

Accordingly, for example, when “a layer B is formed on (or over) a layer A” is explicitly described, it includes both a case where the layer B is formed in direct contact with the layer A, and a case where another layer (e.g., a layer C or a layer D) is formed in direct contact with the layer A, and the layer B is formed in direct contact with the layer C or D. Note that another layer (e.g., a layer C or a layer D) may be a single layer or a plurality of layers.

Similarly, when “B is formed above (or over) A” is explicitly described, it does not necessarily mean that B is formed in direct contact with A, and another object may be interposed between A and B. Accordingly, for example, when “a layer B is formed above a layer A” is explicitly described, it includes both a case where the layer B is formed in direct contact with the layer A, and a case where another layer (e.g., a layer C or a layer D) is formed in direct contact with the layer A, and the layer B is formed in direct contact with the layer C or D. Note that another layer (e.g., a layer C or a layer D) may be a single layer or a plurality of layers.

Note that when it is explicitly described that B is formed in direct contact with A, it includes not the case where another object is interposed between A and B but the case where B is formed in direct contact with A.

Note that the same can be applied to a case where “B is formed below or under A” is explicitly described.

In this documents (specification, claims, drawings, and the like), explicit singular forms preferably mean singular forms. However, without being limited to this, such singular forms can include plural forms. Similarly, explicit plural forms preferably mean plural forms. However, without being limited to this, such plural forms can include singular forms.

By providing a photoelectric conversion device between a liquid crystal display panel and a backlight device, a photoelectric conversion device can effectively detect only the light entering the liquid crystal display panel from the exterior, which affects displaying, without enlarging the liquid crystal display device. Thus, the display luminance of the display portion of the display device can be adjusted appropriately.

Thus, by the present invention, a small-size and highly precise liquid crystal display which has a function of adjusting luminance by using an optical sensor can be provided. By using the function of adjusting luminance, a liquid crystal display device of the present invention can achieve high image quality and low power consumption.

### BRIEF DESCRIPTION OF THE DRAWINGS

In the accompanying drawings:

FIGS. 1A and 1B are diagrams illustrating a liquid crystal display device provided with a photoelectric conversion device of the present invention.

FIGS. 2A to 2C are system blocks of a liquid crystal display device of the present invention.

FIG. 3 is a timing chart of a photoelectric conversion device of the present invention.

FIGS. 4A and 4B are timing charts of a photoelectric conversion device of the present invention.

FIG. 5 is a system block of a display device of the present invention.

FIGS. 6A and 6B are diagrams illustrating a liquid crystal display device provided with a photoelectric conversion device of the present invention.

FIGS. 7A and 7B are diagrams illustrating a liquid crystal display device provided with a photoelectric conversion device of the present invention.

FIGS. 8A and 8B are diagrams illustrating a liquid crystal display device provided with a photoelectric conversion device of the present invention.

FIGS. 9A and 9B are diagrams illustrating a liquid crystal display device provided with a photoelectric conversion device of the present invention.

FIGS. 10A and 10B are diagrams illustrating a liquid crystal display device which has photoelectric conversion devices of the present invention.

FIGS. 11A and 11B are diagrams illustrating a liquid crystal display device which has photoelectric conversion devices of the present invention.

FIGS. 12A and 12B are diagrams illustrating a liquid crystal display device which has a photoelectric conversion device of the present invention.

FIGS. 13A and 13B are cross-sectional views of photoelectric conversion devices of the present invention.

FIG. 14 is a diagram illustrating illuminance dependence with respect to an output current of a photoelectric conversion device of the present invention.

FIG. 15 is a diagram illustrating illuminance dependence with respect to an output current of a photoelectric conversion device of the present invention.

FIG. 16 is a diagram illustrating relative sensitivity of a photoelectric conversion device of the present invention and a spectral luminous efficiency curve.

FIGS. 17A to 17D are diagrams illustrating a manufacturing process of a photoelectric conversion device of the present invention.

FIGS. 18A to 18C are diagrams illustrating a manufacturing process of a photoelectric conversion device of the present invention.

FIGS. 19A to 19C are diagrams illustrating a photoelectric conversion device of the present invention.

FIG. 20 is a cross-sectional view of a photoelectric conversion device of the present invention.

FIGS. 21A to 21E are diagrams illustrating a manufacturing process of a photoelectric conversion device of the present invention.

FIGS. 22A to 22C are diagrams illustrating a manufacturing process of a photoelectric conversion device of the present invention.

FIGS. 23A and 23B are diagrams illustrating a manufacturing process of a photoelectric conversion device of the present invention.

FIG. 24 is a diagram which describes a bias switching unit.

FIG. 25 is a diagram which describes a bias switching unit.

FIGS. 26A and 26B are diagrams which describe bias switching units.

FIGS. 27A and 27B are diagrams which describe bias switching units.

FIGS. 28A and 28B are diagrams which describe bias switching units.

FIG. 29 is a diagram illustrating a device on which a photoelectric conversion device of the present invention is mounted.

FIG. 30 is a diagram illustrating a device on which a photoelectric conversion device of the present invention is mounted.

FIGS. 31A and 31B are diagrams illustrating devices on which a photoelectric conversion device of the present invention is mounted.

FIGS. 32A and 32B are diagrams illustrating a display device provided with a photoelectric conversion device of the present invention.

FIGS. 33A and 33B are diagrams illustrating a device on which a photoelectric conversion device of the present invention is mounted.

FIG. 34 is a diagram illustrating a photoelectric conversion device of the present invention.

### DETAILED DESCRIPTION OF THE PRESENT INVENTION

Embodiment modes of the present invention will be hereinafter described with reference to the drawings. Note that the present invention can be carried out in many different modes, and it is easily understood by those skilled in the art that the mode and the detail of the present invention can be variously changed without departing from the spirit and the scope thereof. Therefore, the present invention is not interpreted as being limited to the description of the embodiment modes. Note that in a structure of the present invention described below, common portions and portions having a similar function are denoted by the same reference numerals in all diagrams, and description thereof is omitted.

### Embodiment Mode 1

This embodiment mode will describe exemplary structure and system blocks of a liquid crystal display device with a photoelectric conversion device. Note that since a liquid crystal display device of the present invention has a backlight device as a light source, a pixel portion of the liquid crystal display panel has a light-transmissive region.

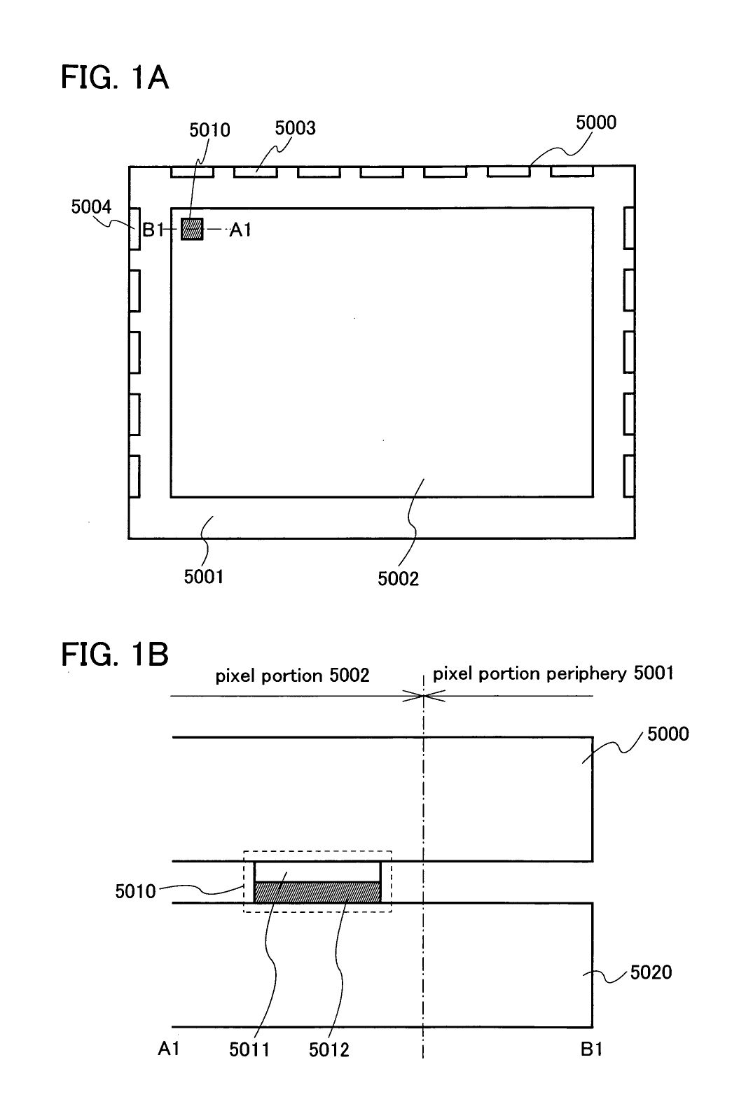

A structure in the case where a photoelectric conversion device is provided in the pixel portion of the back face of the liquid crystal panel is described with reference to FIGS. 1A and 1B.

FIG. 1A is a top view in a case where a photoelectric conversion device is provided in the pixel portion of the back face of the liquid crystal panel. A liquid crystal panel 5000 is divided into a pixel portion 5002 and a pixel portion periphery 5001. A plurality of pixels are provided in the pixel portion 5002 in matrix. A signal line input terminal 5003 and a scan line input terminal 5004 are formed in the pixel portion periphery 5001. In addition, signal lines extend in the column direction from the signal line input terminal 5003, and scan lines extend from the scan line input terminal 5004. Accordingly, by using a signal input to the signal line and a signal input to the scan line, each pixel can be controlled independently. In other word, an image can be displayed on the pixel portion 5002.

Note that the pixel portion periphery 5001 may have a signal line driver circuit, a scan line driver circuit, or various logic circuits. An IC chip may be provided in the pixel portion periphery 5001.

A photoelectric conversion device 5010 is provided in the pixel portion 5002 of the back face of liquid crystal panel 5000. On the viewing side of the display screen of the liquid crystal display panel, a part of the light from the exterior (also called the external light) transmits through the liquid crystal display panel as the incident light, and the other part of the light is reflected to the viewing side as the reflected light. The light which has entered the liquid crystal display panel can be effectively used for displaying. When a photoelectric conversion device is provided on the viewing side of the display screen of the liquid crystal display panel, the light which has been reflected on the surface of the display screen is also detected, and accurate detection of the light may be difficult. Only the light transmitted through the liquid crystal panel 5000 can be detected accurately by using a structure in which the photoelectric conversion device 5010 including a sensor for detecting the light is provided between the liquid crystal panel 5000 and the backlight device 5020, like this embodiment mode.

When the photoelectric conversion device detects light, the liquid crystal panel is in a state of transmitting the light (white display state) in order to detect the external light which transmitted through the liquid crystal panel with the photoelectric conversion device.

Additionally, when the photoelectric conversion device 5010 detects the external light transmitted through the liquid crystal display panel, and the backlight device corresponding to the region is turned off, the photoelectric conversion device 5010 can detect only the external light without detecting the light from the backlight device. The photoelectric conversion device 5010 can be prevented from affecting images displayed on the pixel portion 5002.

FIG. 1B is a cross-sectional view taken along a line A1 to B1 illustrated in FIG. 1A. Note that the similar parts to those of FIG. 1A are denoted the same reference numerals and descriptions of the part is omitted. As described above, the photoelectric conversion device 5010 is provided in the pixel portion 5002 of the back face of the liquid crystal panel. Therefore, as illustrated in FIG. 1B, the photoelectric conversion device 5010 is provided to be interposed between the liquid crystal panel 5000 and the backlight device 5020. Note that the photoelectric conversion device 5010 has the sensor 5011 and driver portion 5012 for the driving the sensor 5011. In addition, the sensor 5011 is provided to face to the liquid crystal panel 5000 side. The driver portion 5012 may be provided under the sensor 5011, aside the sensor 5011, or to cover the sensor 5011 as shown in FIG. 1B, except between the sensor 5011 and the liquid crystal panel 5000. The driver portion 5012 is provided in the backlight device side so as to the driver portion 5012 can block the light entering from the backlight device, which is from opposite side to the liquid crystal panel 5000. Thus, the photoelectric conversion device 5010 can detect the light entered from the liquid crystal panel 5000 side more accurately. Additionally, in the case where the driver portion 5012 can block the light from the backlight device to the sensor 5011, the backlight device is not necessarily turning off when the sensor detects the light.

Note that the place where the photoelectric conversion device 5010 is provided is not limited to the position in FIG. 1A. The photoelectric conversion device 5010 can be provided in various places, as long as the photoelectric conversion device 5010 is provided in the back face of the liquid crystal panel 5000 corresponding to the pixel portion 5002.

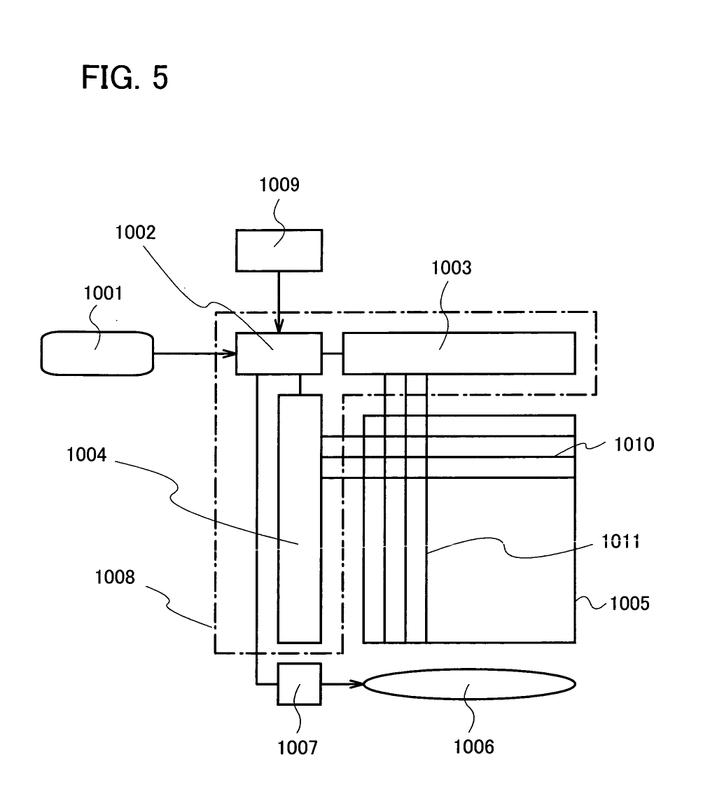

First, an exemplary system block of a liquid crystal display with a photoelectric conversion device is described with reference to FIG. 5.

In a pixel portion 1005, a signal line 1011 is extended from a signal line driver circuit 1003. A scan line 1010 is extended from a scan driver circuit 1004. Further, a plurality of pixels are provided at cross regions of the signal lines 1011 and the scan lines 1010 in matrix. Note that the plurality of pixels each has a switching element. Thus, a voltage for controlling the tilt of liquid crystal molecules can be input independently to each pixel. Accordingly, a structure providing a switching element at each cross region is called an active matrix. However, the structure is not limited to the active matrix like this, and a passive matrix also may be employed. Since the passive matrix does not have switching elements in each pixel, the process is simple and easy.

A photoelectric conversion device 1009 has a function of detecting light. Further, the photoelectric conversion device 1009 has a function of outputting a signal corresponding to the detected light to a control circuit 1002. Note that the signal corresponding to the detected light may be fed back to a video signal 1001.

A driver circuit portion 1008 has the control circuit 1002, the signal line driver circuit 1003, and the scan line driver circuit 1004. A signal output from the photoelectric conversion device 1009 and the video signal 1001 are input to the control circuit 1002. The control circuit 1002 controls the signal line driver circuit 1003 and the scan line driver circuit 1004 in accordance with the signal output from the photoelectric conversion device 1009 and the video signal 1001. Accordingly, the control circuit 1002 outputs a control signal to each of the signal line driver circuit 1003 and the scan line driver circuit 1004. Then, in accordance with the control signal, the signal line driver circuit 1003 output the video signal to the signal line 1011, and the scan line driver circuit 1004 output a scan signal to the scan line 1010. Then, a switching element of a pixel is selected in accordance with the scan signal, and the video signal is input to the pixel selected.

Note that the control circuit 1002 also controls a power supply 1007 corresponding to the signal output from the photoelectric conversion device 1009 and the video signal 1001. The power supply 1007 has means for supplying electricity to a backlight device 1006. The control circuit 1002 adjusts the electricity that the power supply 1007 supplies to the backlight device 1006 in accordance with the signal output from the photoelectric conversion device 1009. For example, when the light amount detected by the photoelectric conversion device 1009 is large, the electricity that the power supply 1007 supplies to the backlight device 1006 is increased in response to the light amount. Accordingly, the display portion of the liquid crystal display device can be prevented from being hardly to watch because of the high luminance of the liquid crystal display device. On the other hand, when the light amount detected by the photoelectric conversion device 1009 is small, the electricity that the power supply 1007 supplies to the backlight device 1006 is decreased in response to the light amount. Accordingly, the luminance of liquid crystal display device is not increased more than necessary so that the power consumption of liquid crystal display device can be reduced. Note that as the backlight device 1006, an edge light type backlight, a direct type backlight or a front light may be used. A front light is a plate-like light unit formed of an illuminant and a light guide body, which is attached to a front side of a pixel portion and illuminates the whole area. By such a backlight device, the pixel portion can be evenly illuminated with low power consumption.

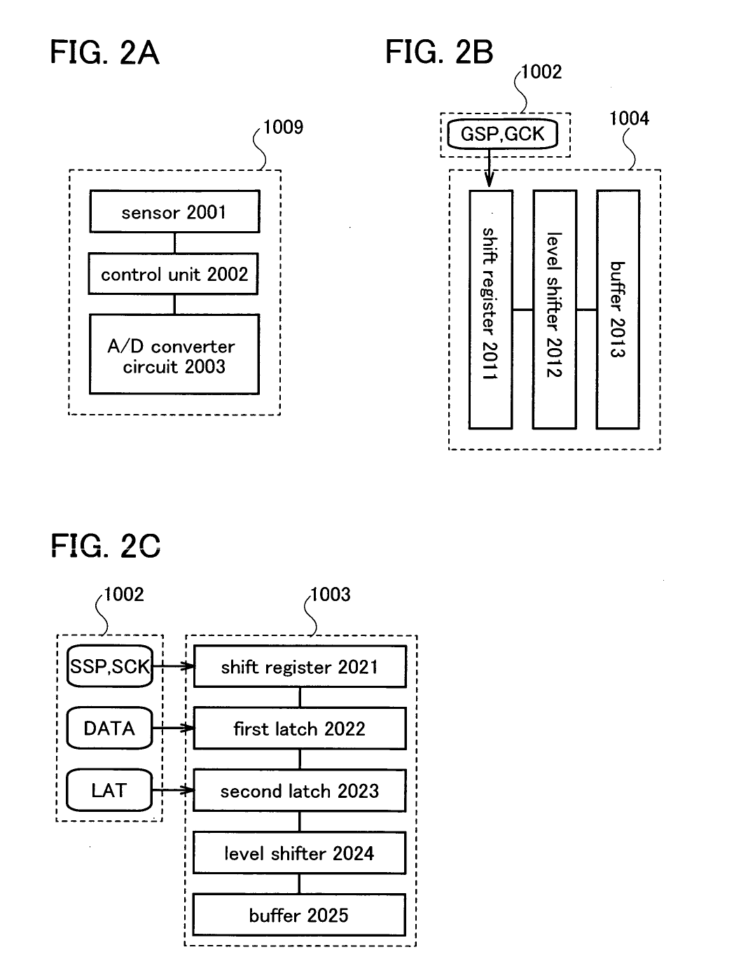

An exemplary structure of the photoelectric conversion device 1009 is described with reference to FIG. 2A. The photoelectric conversion device 1009 has portions functioning as a sensor 2001, a control unit 2002, and an A/D converter circuit 2003. The sensor 2001 has a function of detecting light. The control unit 2002 has a function of controlling the timing of the sensor 2001 detecting light. The A/D converter circuit 2003 has a function of converting a current or a voltage corresponding to light detected by the sensor 2001 from analog values to a digital value. In addition, various structures can be used for the structure of photoelectric conversion device 1009 without being limited to this.

An exemplary structure of the scan line driver circuit 1004 is described with reference to FIG. 2B. The scan line driver circuit 1004 has circuits functioning as a shift register 2011, a level shifter 2012, and a buffer 2013. A signal such as a gate start pulse (GSP) and a gate clock signal (GCK) are inputted to the shift register 2011 from the control circuit 1002. It is to be noted that the scan line driver circuit 1004 is not limited to this structure, and various structures can be used.

An exemplary structure of the signal line driver circuit 1003 is described with reference to FIG. 2C. The signal line driver circuit 1003 has circuits functioning as a shift register 2021, a first latch 2022, a second latch 2023, a level shifter 2024 and a buffer 2025. A circuit functioning as a buffer 2025 is a circuit having a function of amplifying a weak signal, and has an operational amplifier or the like. A signal such as start pulse (SSP) or the like is input into the shift register 2021. Data (DATA) such as a video signal or the like is input into the first latch 2022. A latch signal is input into the second latch 2023. The second latch 2023 can store a signal input from the first latch 2022 temporarily and can output the signals stored in the pixels all at once in accordance with the latch signal. This is referred to as line sequential drive. Note that the case of performing dot sequential drive but line sequential drive, the second latch 2023 is not required. Note that various structures can be used as the structure of the signal line driver circuit 1003 without being limited to this.

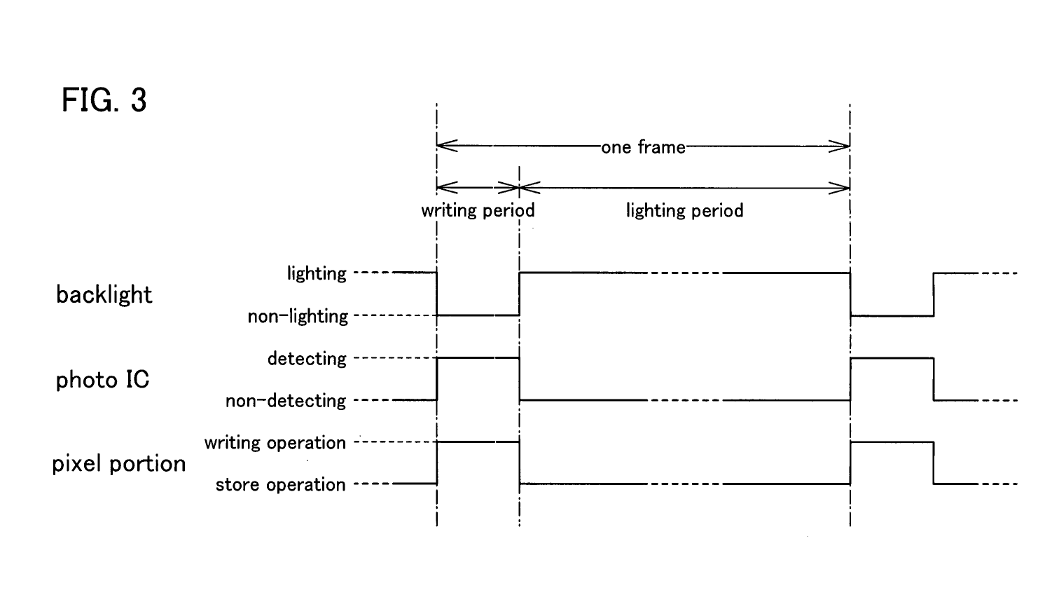

Next an exemplary operation of a system block of a liquid crystal display device having a photoelectric conversion device is described with reference to FIG. 3.

FIG. 3 shows one frame period corresponding to a period for displaying an image for one screen. Although one frame period is not particularly limited to a particular period, it is preferable that one frame period is 1/60 second or less so that an image viewer does not perceive flickers. Note that a timing chart of FIG. 3 is a timing of a backlight device (illumination means) turning on, a timing at which a photoelectric conversion device detects the light, and a timing of writing a video signal in a pixel portion (a timing of scaning).

In the timing chart of FIG. 3, one frame period can be divided into a writing period and a lighting period.

Operation in a writing period is described. In the writing period, a video signal is input into each pixel. In other words, a scan line is scanned in the writing period, and a video signal is input into each pixel. Note that the backlight device is a non-lighting state in the writing period. At that time the photoelectric conversion device detects light. Accordingly, the photoelectric conversion device can accurately detect the external light. Since the backlight device does not turn on, the photoelectric conversion device can detect only the external light.

Operation in a lighting period is described. In a lighting period, operation of writing a video signal to each pixel is not performed. Thus, each pixel stores the video signal input in the writing period. Then, the liquid crystal element of each pixel has transmissivity in accordance with the video signal. At this time, an image corresponding to the video signal can be displayed by the backlight device turned on.

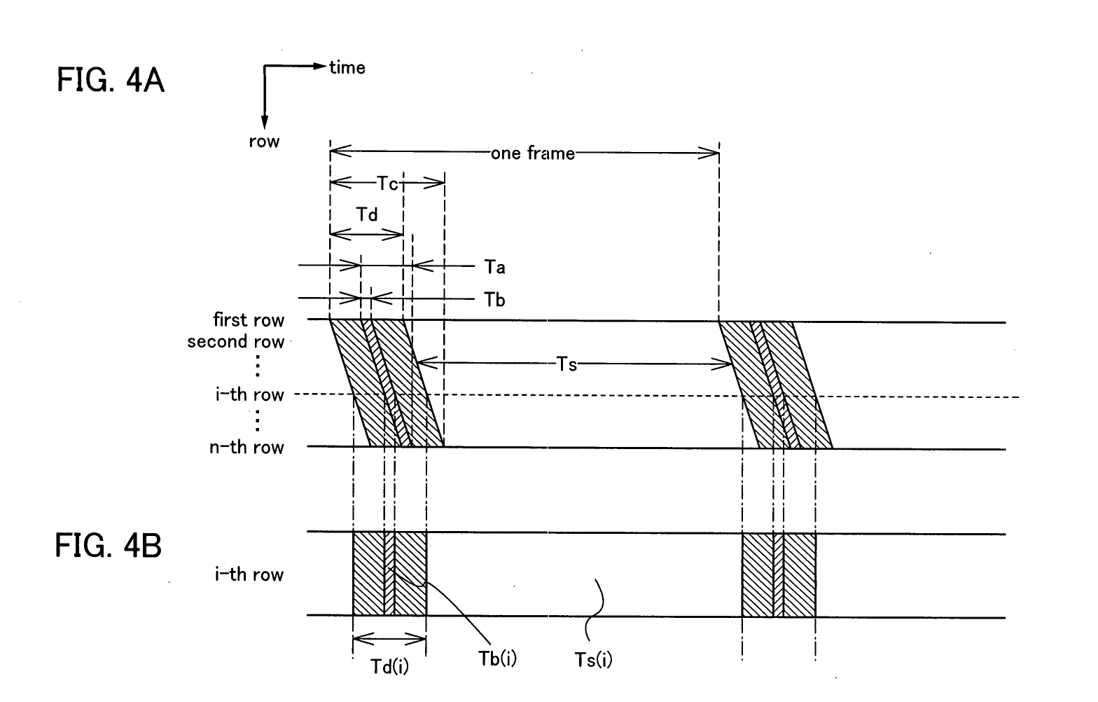

An exemplary operation of a system block of a liquid crystal display device with a photoelectric conversion device, which is different from FIG. 3, is described with reference to FIGS. 4A and 4B.

FIG. 4A shows one frame period corresponding to a period for displaying an image for one screen. Although one frame period is not particularly limited to a particular period, it is preferable that one frame period is 1/60 second or less so that an image viewer does not perceive flickers.

The operation is described. First, a scan signal is input into a scan line sequentially from the first line in a writing period Ta, and a pixel is selected. Then, when the pixel is selected, a video signal is input to the pixel from a signal line. Then, the video signal is written into the pixel, the pixel stores the signal until a signal is input again. Gray scales of each pixel in a display period Ts are controlled by the written video signal. Note that the backlight device turns off in accordance with the operation for scanning a scan line in a backlight device turning-off period Tc. The backlight device turning-off period Tc is longer than a writing period Ta. In the backlight device turning-off period Tc, the photoelectric conversion device detects the light when the backlight device, which a photoelectric conversion device is placed nearby, turns off. Accordingly, the photoelectric conversion device can accurately detect the external light. Since the backlight device does not turn on, the photoelectric conversion device can detect only the external light.

Here, description is made focusing on a pixel row in i-th row with reference to FIG. 4B. First, a scan signal is input into a scan line sequentially from the first line in a writing period Ta. Then a pixel of i-th row is selected in a period Th (i) of a writing period Ta. A video signal is input into a pixel of i-th row from a signal line when the pixel of i-th row is selected. Then, when the video signal is written into a pixel of i-th row, the pixel of i-th stores the signal until a signal is input again. Gray scales of the pixel of i-th row in a display period Ts (i) are controlled by the written video signal. Note that the backlight device is non-lighting state in a period Th (i) and before and after of the period. A period when the backlight device turns off is a period Td (i). In the case where a photoelectric conversion device is provided nearby the i-th row, the photoelectric conversion device detects light in a period Td (i). Accordingly, the photoelectric conversion device can accurately detect the external light. Since the backlight device does not turn on, the photoelectric conversion device can detect only the external light.

In this embodiment mode to which the present invention is applied, by providing a photoelectric conversion device between a liquid crystal display panel and a backlight device, an optical sensor can effectively detect only the light, which enters the liquid crystal display panel from the exterior and affects displaying, without enlarging the liquid crystal display device. Thus, the display luminance of the display portion of the liquid crystal display device can be adjusted appropriately.

Thus, by the present invention, a smaller-size and highly precise liquid crystal display which has a function of adjusting luminance by using an optical sensor is provided. By using the function of adjusting luminance, a liquid crystal display device of the present invention can achieve high image quality and low power consumption.

Although this embodiment mode is described with reference to various drawings, the contents (or a part thereof) described in each drawing can be freely applied to, combined with, or replaced with the contents (or a part thereof) described in another drawing. Further, even more drawings can be formed by combining each part with another part in the above-described drawings.

Similarly, the contents (or a part thereof) shown in each drawing of this embodiment mode can be freely applied to, combined with, or replaced with the contents (or a part thereof) described in a drawing in another embodiment mode. Further, even more drawings can be formed by combining each part with part of another embodiment mode in the drawings of this embodiment mode.

Note that this embodiment mode shows an example of an embodied case of the contents (or a part thereof) described in other embodiment modes, an example of slight transformation thereof, an example of partial modification thereof, an example of improvement thereof, an example of detailed description thereof, an application example thereof, an example of related part thereof, or the like. Therefore, the contents described in other embodiment modes can be freely applied to, combined with, or replaced with this embodiment mode.

### Embodiment Mode 2

In this embodiment mode, a structure of the case where a photoelectric conversion device is provided in the back face of a liquid crystal panel, which is different from embodiment mode 1, is described. Note that a structure of a liquid crystal panel described in this embodiment mode can employ various structures without particular limitation. Note that a structure of a photoelectric conversion device described in this embodiment mode can employ various structures without particular limitation. Note that a structure of a backlight device described in this embodiment mode can employ various structures without particular limitation.

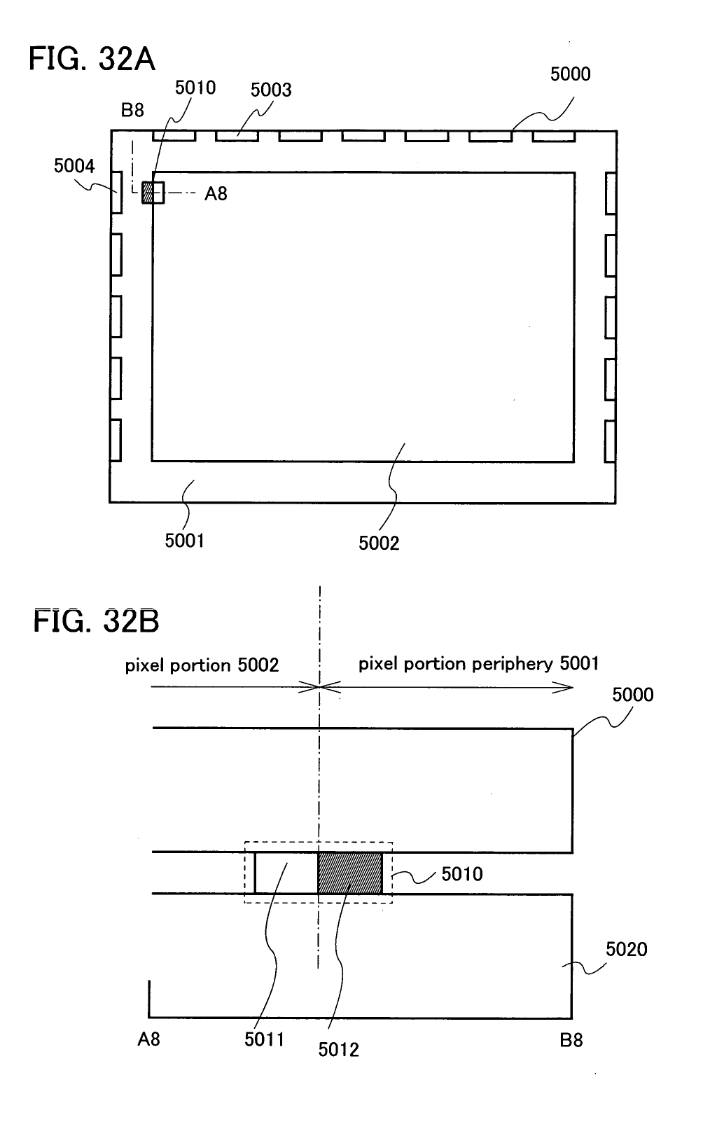

A structure in the case where a photoelectric conversion device is provided in the pixel portion of the back face of the liquid crystal panel is described with reference to FIGS. 32A and 32B. Note that the similar parts to those of FIGS. 1A and 1B described in Embodiment Mode 1 are denoted by the same reference numerals, and descriptions of such parts are omitted.

FIG. 32A is a top plan view in the case where a photoelectric conversion device is provided in a pixel portion of the back face of a liquid crystal panel, and a part of the photoelectric conversion device is provided on a pixel portion periphery of the back face of a liquid crystal panel. Note that a sensor of the photoelectric conversion device 5010 is provided in the pixel portion 5002 of the back face of the liquid crystal panel 5000. On the other hand, a driver portion of the photoelectric conversion device 5010 may be provided in the pixel portion 5002 of the back face of the liquid crystal panel 5000, or the driver portion may be provided on the pixel portion periphery 5001 of the back face of the liquid crystal panel 5000. Accordingly, reduction of the amount of the light which transmits through the pixel portion 5002 of the liquid crystal panel 5000 can be suppressed.

FIG. 32B is a cross-sectional view taken along a line A8-B8 shown in FIG. 32A. Note that the similar parts to those of FIG. 32A are denoted by the same reference numerals, and descriptions of such parts are omitted. As described above, the photoelectric conversion device 5010 is provided in the pixel portion 5002 of the back face of liquid crystal panel 5000, and a part of it is provided on the pixel portion periphery 5001 of the back face of the liquid crystal panel. Thus, as shown in FIG. 32B, the photoelectric conversion device 5010 is provided to be interposed between the liquid crystal panel 5000 and the backlight device 5020. Note that the photoelectric conversion device 5010 has the sensor 5011 and the driver portion 5012 for the driving the sensor 5011. In addition, the sensor 5011 is provided between the backlight device 5020 and the pixel portion 5002 of the liquid crystal panel 5000. The driver portion 5012 is provided between the backlight device 5020 and the pixel portion periphery 5001 of and liquid crystal panel 5000. Accordingly, reduction of the light amount which transmits through the pixel portion 5002 of the liquid crystal panel 5000 can be suppressed.

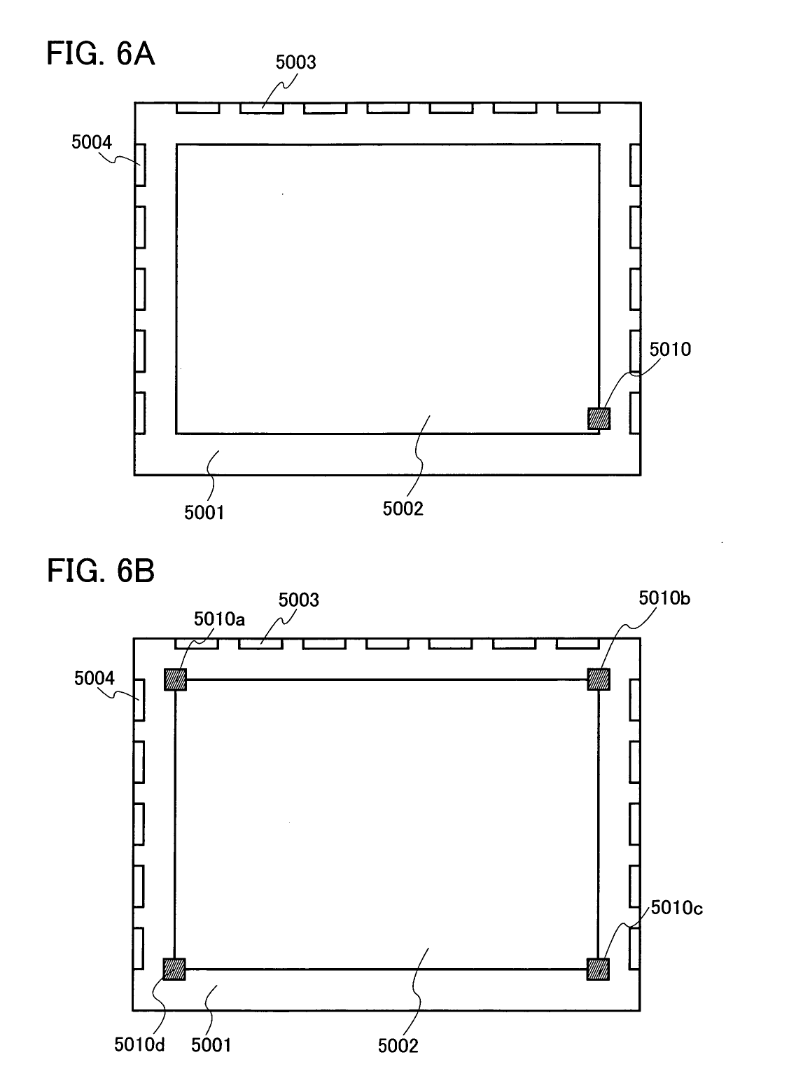

Note that the place where the photoelectric conversion device 5010 is provided is not limited to the case of FIG. 32A. The photoelectric conversion device 5010 can be provided in various places as long as it is provided in the back face of the liquid crystal panel 5000 which corresponds to the pixel portion 5002. For example, as shown in FIG. 6A, the photoelectric conversion device 5010 may be provided in a place which is different from FIG. 32A. Alternatively, as shown in FIG. 6B, a plurality of photoelectric conversion devices (a photoelectric conversion device 5010a, a photoelectric conversion device 5010b, a photoelectric conversion device 5010c and a photoelectric conversion device 5010d) may be provided. Accordingly, each the photoelectric conversion device detects light, and the data on the light is averaged to obtain the surrounding brightness of the liquid crystal display device. Thus, accurate brightness level of the surrounding of the liquid crystal display device can be obtained.

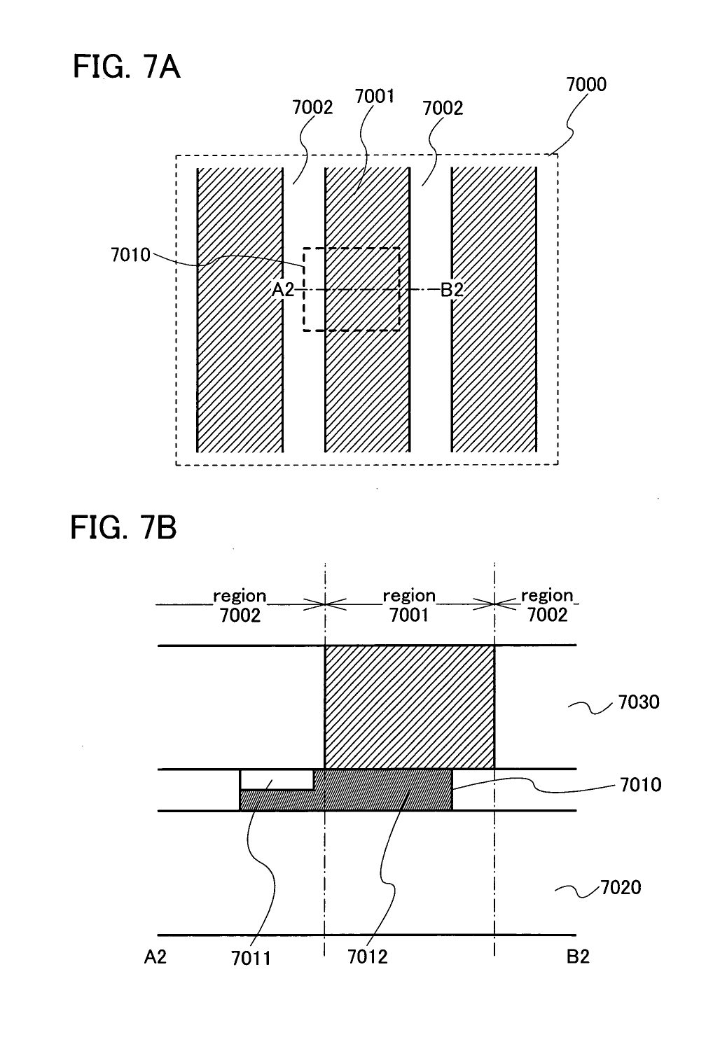

A structure in the case where a photoelectric conversion device is provided in a pixel portion of the back face of a liquid crystal panel, which is more detailed than FIGS. 1A, 1B, 6A, 6B, 32A and 32B, is described with reference to FIGS. 7A and 7B.

FIG. 7A is a top plan view illustrating the case where a photoelectric conversion device is provided on a pixel portion periphery of the back face of a liquid crystal panel. Note that FIG. 7A is a top plan view of a region 7000 which enlarged pixel portion periphery. The region 7000 can be divided into a light-shielding region 7001 and a light-transmitting region 7002. The light-shielding region 7001 is a region which does not transmit light. The light-transmitting region 7002 is a region which transmits light. In FIG. 7A, a wiring is formed in the light-shielding region 7001, and nothing is formed in the light-transmitting region 7002. Note that in the light-shielding region 7001, a black matrix, a transistor, a reflective electrode or various elements may be formed in addition to a wiring. Alternatively, an IC chip or the like may be provided. Note that, a film formed with a material having transparency, a thin film having a light-transmitting property, silicon, or the like may be formed in the light-transmitting region 7002.

The photoelectric conversion device 7010 is provided in the light-shielding region 7001 of the back face of the liquid crystal panel. In addition, a part of the photoelectric conversion device 7010 is provided in the light-transmitting region 7002 of the back face of the liquid crystal panel.

FIG. 7B is a cross-sectional view taken along a line A2-B2 shown in FIG. 7A. Note that the similar parts to those of FIG. 7A are denoted by the same reference numerals, and descriptions of such parts is omitted. As mentioned above, the photoelectric conversion device 7010 is provided on the pixel portion periphery of the back face of liquid crystal panel. Thus, as shown in FIG. 7B, the photoelectric conversion device 7010 is provided to be interposed between a liquid crystal panel 7030 and a backlight device 7020. Note that the photoelectric conversion device 7010 can be divided into a sensor 7011 and a driver portion 7012 for the driving the sensor 7011. Then, the sensor 7011 is provided in the light-transmitting region 7002 of the pixel portion periphery of the liquid crystal panel 7030. The large part of the driver portion 7012 is provided in the light-shielding region 7001 of the pixel portion periphery of the back face of the liquid crystal panel 7030. Accordingly, the photoelectric conversion device 7010 can be provided in a region in which the light-transmitting region 7002 is small (a place where a plurality of wirings are formed or the like). The reason for this will be described. When the sensor 7011 is provided in the place where the external light enters, the photoelectric conversion device 7010 can detect the external light. The driver portion 7012 is not necessary to be provided in the place where the external light enters. Thus, as shown in FIG. 7A, when the sensor 7011 is provided in the light-transmitting region 7002, the photoelectric conversion device 7010 can detect the external light, even if the driver portion 7012 is provided in the light-shielding region 7001.

Note that the photoelectric conversion device 7010 can be provided in various places without being limited to this arrangement. The photoelectric conversion device 7010 can be provided, for example, in the place where a transistor is provided, a black matrix is formed, or the like.

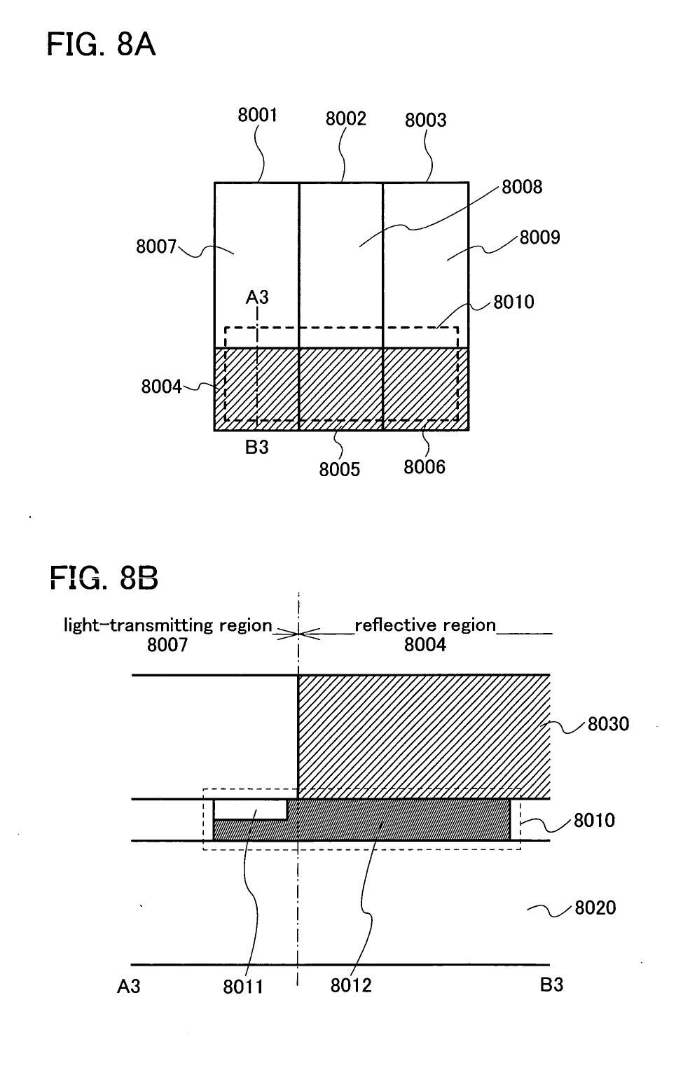

A structure in the case where a photoelectric conversion device is provided in a pixel portion of the back face of a liquid crystal panel, which is different from FIGS. 7A and 7B, is described with reference to FIGS. 8A and 8B.

FIG. 8A is a top plan view in the case where a photoelectric conversion device is provided in a pixel portion of the back face of a liquid crystal panel. Note that FIG. 8A illustrates an enlarged pixel portion, and shows a pixel 8001, a pixel 8002, and a pixel 8003. Although it is not illustrated, a plurality of pixels are provided in a pixel portion in addition to that. The pixel 8001, the pixel 8002 and the pixel 8003 have a semi-transmissive structure. Thus, the pixel 8001 is divided into a reflective region 8004 and a light-transmitting region 8007. Similarly, the pixel 8002 is divided into a reflective region 8005 and a light-transmitting region 8008, and the pixel 8003 is divided into a reflective region 8006 and a light-transmitting region 8009. Each of the reflective region 8004, the reflective region 8005 and the reflective region 8006 has a function of reflecting light when the light enters. Each of the light-transmitting region 8007, the light-transmitting region 8008 and the light-transmitting region 8009 has a function of transmitting the light from a backlight device.

A photoelectric conversion device 8010 is provided in the each reflective region (the reflective region 8004, the reflective region 8005 and the reflective region 8006) of the back face of the liquid crystal panel. A part of the photoelectric conversion device 8010 is provided in the each light-transmitting region (the light-transmitting region 8007, the light-transmitting region 8008 and the light-transmitting region 8009) of the back face of the liquid crystal panel. Accordingly, decreasing of the area that a pixel can transmit the light can be reduced, although a photoelectric conversion device is provided in a pixel portion.

FIG. 8B is a cross-sectional view taken along a line A3-B3 shown in FIG. 8A. Note that the similar parts to those of FIG. 8A are denoted by the same reference numerals, and descriptions of such parts are omitted. As described above, the photoelectric conversion device 8010 is provided in the pixel portion of the back face of liquid crystal panel. Thus, as shown in FIG. 8B, the photoelectric conversion device 8010 is provided to be interposed between a liquid crystal panel 8030 and a backlight device 8020. Note that the photoelectric conversion device 8010 can be divided into a sensor 8011 and a driver portion 8012 for the driving the sensor 8011. In addition, the sensor 8011 is provided in a light-transmitting region 8007 of the pixel in the liquid crystal panel 8030. A large part of the driver portion 8012 is provided in the reflective region 8004 of the back face of the liquid crystal panel 8030. Accordingly, luminance decay can be suppressed even if the photoelectric conversion device is provided in the pixel portion of the back face of the liquid crystal panel.

Note that processes for forming a reflective electrode in the pixel can be reduced by forming a material having reflectivity to the driver portion 8012 of the photoelectric conversion device 8010. Alternatively, the processes for forming a reflective electrode in the pixel can be reduced by using reflective material for a part of the driver portion 8012.

Note that in FIGS. 8A and 8B, in the case where one photoelectric conversion device is provided in the three pixel regions is described; however various structures can be used without being limited to this structure. For example, one photoelectric conversion device may be provided in one pixel. One photoelectric conversion device may be provided in the four or more pixel regions.

Note that photoelectric conversion devices may be provided in the all of pixel regions. Alternatively, a photoelectric conversion device may be provided only in a particular pixel region.

Note that in FIGS. 8A and 8B, in a case where a photoelectric conversion device is provided in a pixel portion is described; however, a photoelectric conversion device may be provided in a region where a pixel not contributed to display is formed.

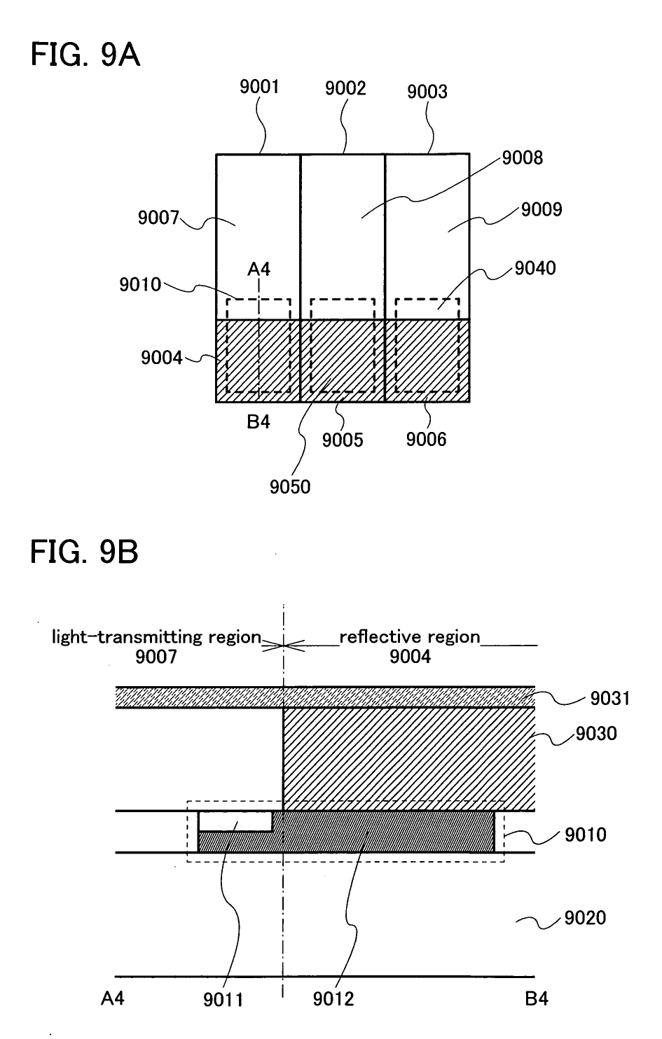

A structure in the case where a photoelectric conversion device is provided in the pixel portion of the back face of the liquid crystal panel, which is different from FIGS. 8A and 8B, is described with reference to FIGS. 9A and 9B.

FIG. 9A is a top plan view in the case where a photoelectric conversion device is provided in a pixel portion of the back face of the liquid crystal panel. Note that FIG. 9A illustrates enlarged pixel portion, and shows a pixel 9001, a pixel 9002, and a pixel 9003. Although it is not illustrated, a plurality of pixels are provided in a pixel portion. The pixel 9001, the pixel 9002 and the pixel 9003 have a semi-transmissive structure. Thus, the pixel 9001 is divided into a reflective region 9004 and a light-transmitting region 9007. Similarly, the pixel 9002 is divided into a reflective region 9005 and a light-transmitting region 9008, and the pixel 9003 is divided into a reflective region 9006 and a light-transmitting region 9009. Each of the reflective region 9004, the reflective region 9005, and the reflective region 9006 has a function of reflecting the light when the light enters. Each of the light-transmitting region 9007, a light-transmitting region 9008, and a light-transmitting region 9009 has a function of transmitting the light from a backlight device.

A photoelectric conversion device 9010 is provided in the reflective region 9004 of the back face of the liquid crystal panel. A part of the photoelectric conversion device 9010 is provided in the light-transmitting region 9007 of the back face of the liquid crystal panel. Similarly, a photoelectric conversion device 9050 is provided in the reflective region 9005 of the back face of the liquid crystal panel. A part of the photoelectric conversion device 9050 is provided in the light-transmitting region 9008 of the back face of the liquid crystal panel. Similarly, a photoelectric conversion device 9040 is provided in the reflective region 9006 of the back face of the liquid crystal panel. A part of the photoelectric conversion device 9040 is provided in the light-transmitting region 9009 of the back face of the liquid crystal panel. Accordingly, reduction of the pixel area that the pixel can transmit light can be suppressed, although the photoelectric conversion devices are provided in a pixel portion.

FIG. 9B is a cross-sectional view taken along a line A4-B4 shown in FIG. 9A. Note that the similar parts to those of FIG. 9A are denoted by the same reference numerals, and descriptions of such parts are omitted. As described above, the photoelectric conversion device 9010 is provided in the pixel portion of the back face of the liquid crystal panel. Thus, as shown in FIG. 9B, the photoelectric conversion device 9010 is provided to be interposed between a liquid crystal panel 9030 and a backlight device 9020. Note that the photoelectric conversion device 9010 can be divided into a sensor 9011 and a driver portion 9012 for the driving the sensor 9011. Note that each of the photoelectric conversion device 9040 and the photoelectric conversion device 9050 also can be divided into a sensor and a driver portion. In addition, the sensor 9011 is provided in a light-transmitting region 9007 of the pixel portion of the liquid crystal panel 9030. A large part of the driver portion 9012 is provided in the reflective region 9004 of the back face of the liquid crystal panel 9030. Note that the photoelectric conversion device 9050 and the photoelectric conversion device 9040 are also provided in the pixel 9002 and the pixel 9003 respectively similar to the photoelectric conversion device 9010. Accordingly, luminance decay can be suppressed even if the photoelectric conversion device is provided in the pixel portion of the back face of the liquid crystal panel. Note that the sensor of the photoelectric conversion device (the sensor 9011) detects external light through a color filter 9031. Accordingly, the photoelectric conversion device can detect only light of a particular color element.

Note that when color filters for R, G and B are provided in the pixel 9001, the pixel 9002 and the pixel 9003 respectively, the photoelectric conversion device 9010, the photoelectric conversion device 9050, and the photoelectric conversion device 9040 can detect only the external light of an R color element, the external light of a G color element, the external light of a B color element respectively.

Note that processes for forming a reflective electrode in the pixel can be reduced by forming a material having reflective property for each the driver portion of the photoelectric conversion device 9010, the photoelectric conversion device 9050, and the photoelectric conversion device 9040. Alternatively, processes for forming a reflective electrode in the pixel can be reduced by using material having reflective property for a part of the driver portion of the photoelectric conversion device 9010, the photoelectric conversion device 9040, and the photoelectric conversion device 9050.

Note that photoelectric conversion devices may be provided in the all of pixels formed in the pixel portion. Alternatively, a photoelectric conversion device may be provided only in a particular pixel.

Note that in FIGS. 9A and 9B, a case where a photoelectric conversion device is provided in a pixel portion is described; however, a photoelectric conversion device may be provided in a region where a pixel not contributed to display is formed.

In this embodiment mode to which the present invention is applied, by providing a photoelectric conversion device between a liquid crystal panel and a backlight device, an optical sensor can effectively detect only the light entering the liquid crystal panel from the exterior, which affects displaying, without enlarging the liquid crystal display device. Thus, the display luminance of the display portion of the liquid crystal display device can be adjusted appropriately.

Thus, by the present invention, a smaller-size and highly precise liquid crystal display which has a function of adjusting luminance by using an optical sensor is provided. By using the function of adjusting luminance, the liquid crystal display device of the present invention can achieve high image quality and low power consumption.

Although this embodiment mode is described with reference to various drawings, the contents (or a part thereof) described in each drawing can be freely applied to, combined with, or replaced with the contents (or a part thereof) described in another drawing. Further, even more drawings can be formed by combining each part with another part in the above-described drawings.

Similarly, the contents (or a part thereof) described in each drawing of this embodiment mode can be freely applied to, combined with, or replaced with the contents (or a part thereof) described in a drawing in another embodiment mode. Further, even more drawings can be formed by combining each part with part of another embodiment mode in the drawings of this embodiment mode.

Note that this embodiment mode shows an example of an embodied case of the contents (or a part thereof) described in other embodiment modes, an example of slight transformation thereof, an example of partial modification thereof, an example of improvement thereof, an example of detailed description thereof, an application example thereof, an example of related part thereof, or the like. Therefore, the contents described in other embodiment modes can be freely applied to, combined with, or replaced with this embodiment mode.

### Embodiment Mode 3

In this embodiment mode, a structure of the case where a photoelectric conversion device is provided in a backlight device is described. Note that a structure of a liquid crystal panel described in this embodiment mode is not limited; thus, various structures can be employed. Note that a structure of a photoelectric conversion device described in this embodiment mode is not limited; thus various structures can be employed. Note that a structure of a backlight device described in this embodiment mode is not limited; thus various structures can be employed.

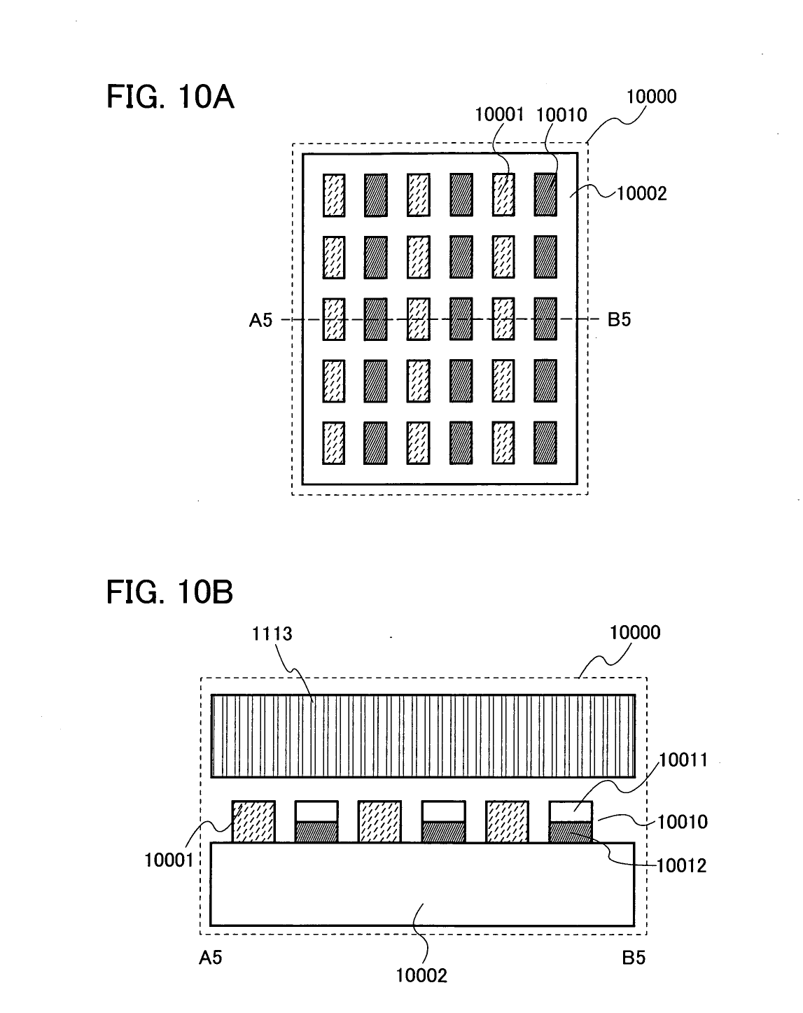

A structure in the case where a photoelectric conversion device is provided in a backlight device is described with reference to FIGS. 10A and 10B.

FIG. 10A is a top plan view in the case where a photoelectric conversion device is provided in a direct type backlight device. A plurality of light sources 10001 and a plurality of photoelectric conversion devices 10010 are provided over a housing 10002 in a backlight device 10000. Note that a light guide plate, a reflector plate, a diffuser panel, a lamp reflector, and the like are not shown in this description. Note that a structure in a case of using a light emitting diode as the light source 10001 is described. When the light source 10001 and the photoelectric conversion device 10010 are provided over the same housing 10002, increase of a space to provide a photoelectric conversion device 10010 can be suppressed. Since the photoelectric conversion device 10010 can detect the light transmitted through the display portion of the liquid crystal panel, brightness of the periphery of the display portion can be detected.

Note that the light source 10001 is not limited to a light emitting diode, and various structures can be employed. For example, a cold cathode tube, a hot cathode tube, an inorganic EL, an organic EL or the like can be used as the light source 10001.

FIG. 10B is a cross-sectional view taken along a line A5-B5 shown in FIG. 10A. Note that the similar parts to those of FIG. 10A are denoted by the same reference numerals, and descriptions of such parts are omitted. As described above, the photoelectric conversion device 10010 is provided over the housing 10002 in which the light source 10001 is provided. Note that the photoelectric conversion device 10010 is divided into a sensor 10011 and a driver portion 10012 for the driving the sensor 10011. Additionally, the sensor 10011 is provided such that the light entered from the upper side can be detected. The driver portion 10012 is provided under the sensor 10011. In this way, the arrangement area of the photoelectric conversion device 10010 can be reduced. Note that the driver portion 10012 can be provided in various places without being limited to the position under the sensor 10011, as long as the diver portion 10012 does not block the light which the sensor 10011 detects.

Note that an optical sheet 1113 is provided over the housing 10002 which is provided with the light source 10001 and the photoelectric conversion device 10010. The optical sheet 1113 includes a light guide plate, a reflector plate, a diffuser panel, and/or the like. For example, when the light source 10001 turns off, the photoelectric conversion device 10010 detects the external light diffused by the optical sheet 1113. On the other hand, when the light source 10001 turns on, the photoelectric conversion device 10010 detects the light from the light source 10001. Therefore, the liquid crystal display device illustrated in FIGS. 10A and 10B can detect the brightness of the external light and the brightness of the backlight device.

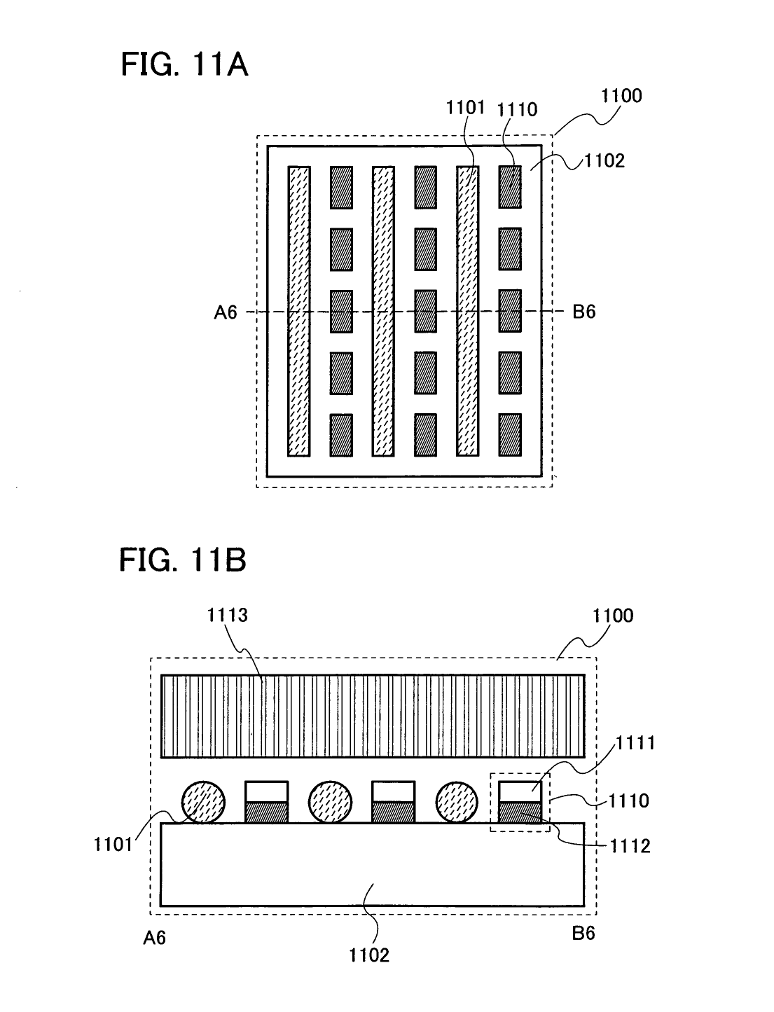

A structure in the case where a photoelectric conversion device is provided in a backlight device, which is different from FIGS. 10A and 10B, is described with reference to FIGS. 11A and 11B. Note that the difference between FIGS. 10A and 10B, and FIGS. 11A and 11B is that a cold cathode tube is used as a light source.

FIG. 11A is a top plan view in the case where a photoelectric conversion device is provided in a direct type backlight device. A plurality of light sources 1101 and a plurality of photoelectric conversion devices 1110 are provided over a housing 1102 in a backlight device 1100. Note that a light guide plate, a reflector plate, a diffuser panel, a lamp reflector, and the like are not shown in this specification. Note that a structure in a case of using a cold cathode tube as the light source 1101 is described. When the light source 1101 and the photoelectric conversion device 1110 are provided over the same housing 1102, increase of a space to provide the photoelectric conversion device 1110 can be suppressed. Since the photoelectric conversion device 1110 can detect the light transmitted through the display portion of the liquid crystal panel, brightness of the periphery of the display portion can be detected.

Note that the light source 1101 is not limited to a cold cathode tube, and various structures can be employed. The light source 1101 includes, for example, a hot cathode tube, a light emitting diode, an inorganic EL, an organic EL or the like.

FIG. 11B is a cross-sectional view taken along a line A6-B6 shown in FIG. 11A. Note that the similar parts to those of FIG. 11A are denoted by the same reference numerals, and descriptions of such parts are omitted. As described above, the photoelectric conversion device 1110 is provided over the housing 1102 in which the light source 1101 is provided. Note that the photoelectric conversion device 1110 is divided into a sensor 1111 and a driver portion 1112 for the driving the sensor 1111. Additionally, the sensor 1111 is provided such that light entered from the upper side can be detected. The driver portion 1112 is provided under the sensor 1111. In this manner, the arrangement area of the photoelectric conversion device 1110 can be reduced. Note that the driver portion 1112 can be provided in various places without being limited to the position under the sensor 1111, as long as the diver portion 1112 does not block the light which the sensor 1111 detects.

Note that the optical sheet 1113 is provided over the housing 1102 which is provided with the light source 1101 and the photoelectric conversion device 1110. The optical sheet 1113 includes a light guide plate, a reflector plate, a diffuser panel, and/or the like. For example, when the light source 1101 turns off, the photoelectric conversion device 1110 detects the external light diffused by the optical sheet 1113. On the other hand, when the light source 1101 turns on, the photoelectric conversion device 1110 detects the light from the light source 1101. Therefore, the liquid crystal display device illustrated in FIGS. 11A and 11B can detect the brightness of the external light and the brightness of the backlight device.

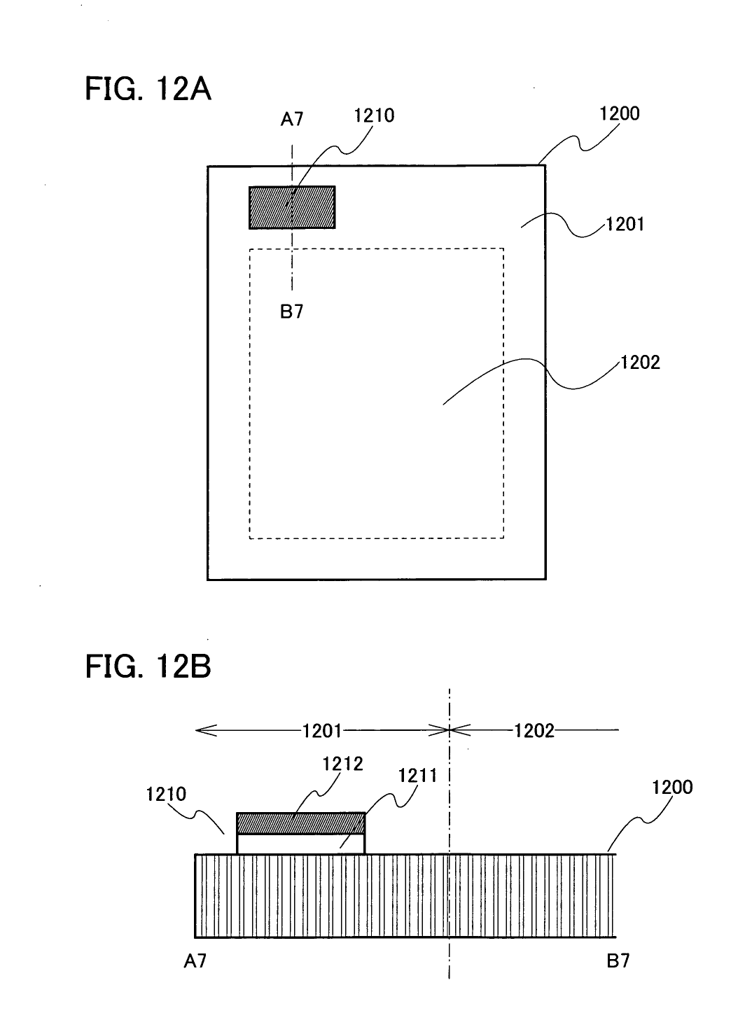

A structure in the case where a photoelectric conversion device is provided in a backlight device, which is different from FIGS. 10A to 11B is described with reference to FIGS. 12A and 12B.

FIG. 12A is a top plan view in the case where a photoelectric conversion device is provided over an optical sheet 1200 of a backlight device. Note that in FIG. 12A, description is made with a light source and the like are not shown. Note that the optical sheet 1200 includes a light guide plate, a reflector plate, a diffuser panel, and/or the like. Note that the optical sheet 1200 is divided into a region corresponding to a pixel portion periphery 1201 and a region corresponding to a pixel portion 1202. The photoelectric conversion device 1210 is provided in the region corresponding to the pixel portion periphery 1201. Note that the region corresponding to the pixel portion periphery 1201 is the region under the pixel portion periphery of a liquid crystal panel. The region corresponding to the pixel portion 1202 is a region under the pixel portion of a liquid crystal panel.

Note that the backlight device used in FIG. 12 can employ various structures. Examples of the backlight device used for FIGS. 12A and 12B include a direct type backlight device, or an edge light type backlight device.

Note that the photoelectric conversion device 1210 can be provided in various places without being limited to that in FIG. 12A. Note that the number of the photoelectric conversion devices 1210 to be provided may be two or more without being limited to the number of FIG. 12A.

FIG. 12B is a cross-sectional view taken along a line A7-B7 shown in FIG. 12A. Note that the similar parts to those of FIG. 12A is denoted by the same reference numerals, and descriptions of such parts are omitted. As mentioned above, the photoelectric conversion device 1210 is provided over the optical sheet 1200. Note that the photoelectric conversion device 1210 is divided into a sensor 1211 and a driver portion 1212 for the driving the sensor 1211. In addition, the sensor 1211 is provided in contact with the optical sheet 1200. The driver portion 1212 is provided on the sensor 1211. Additionally, the photoelectric conversion device 1210 can detect the light from the optical sheet 1200. This is described specifically. The light from the optical sheet 1200 is diffused external light when the backlight device is turning off. In other words, the external light is detected by the photoelectric conversion device 1210 through the optical sheet 1200. Therefore, it is not necessary to enter the external light to the region corresponding to a pixel portion periphery 1201, and various elements are provided or formed in the pixel portion periphery of the liquid crystal panel. Note that when the backlight device emits light, the photoelectric conversion device 1210 can detect the luminance of the backlight device through the optical sheet 1200.

Note that in this embodiment mode, a plurality of the photoelectric conversion devices may be provided in the backlight device. The plurality of the photoelectric conversion devices may have different structures or shapes in accordance with arrangement, light amount to be detected, color elements to be detected, or the like.

Note that since a photoelectric conversion device is provided in a backlight device, a liquid crystal display device can be small. Additionally, deterioration of the backlight device can be corrected by the photoelectric conversion device detecting the light from the light source. The intensity of the light from the backlight device can be controlled by detecting the external light, which enters the liquid crystal display panel from the exterior and affects the display, with the sensor, and by feeding back the data to the backlight device. Thus, variations in display luminance of the display portion can be prevented and high quality display can be achieved. Further, since the external light can be used effectively, excessive drive of the backlight device can be prevented, and thus, a liquid crystal display device with high reliability and low power consumption can be achieved.

Although this embodiment mode is described with reference to various drawings, the contents (or a part thereof) described in each drawing can be freely applied to, combined with, or replaced with the contents (or a part thereof) described in another drawing. Further, even more drawings can be formed by combining each part with another part in the above-described drawings.

Similarly, the contents (or a part thereof) described in each drawing of this embodiment mode can be freely applied to, combined with, or replaced with the contents (or a part thereof) described in a drawing in another embodiment mode. Further, even more drawings can be formed by combining each part with part of another embodiment mode in the drawings of this embodiment mode.

Note that this embodiment mode shows an example of an embodied case of the contents (or a part thereof) described in other embodiment modes, an example of slight transformation thereof, an example of partial modification thereof, an example of improvement thereof, an example of detailed description thereof, an application example thereof, an example of related part thereof, or the like. Therefore, the contents described in other embodiment modes can be freely applied to, combined with, or replaced with this embodiment mode.

### Embodiment Mode 4

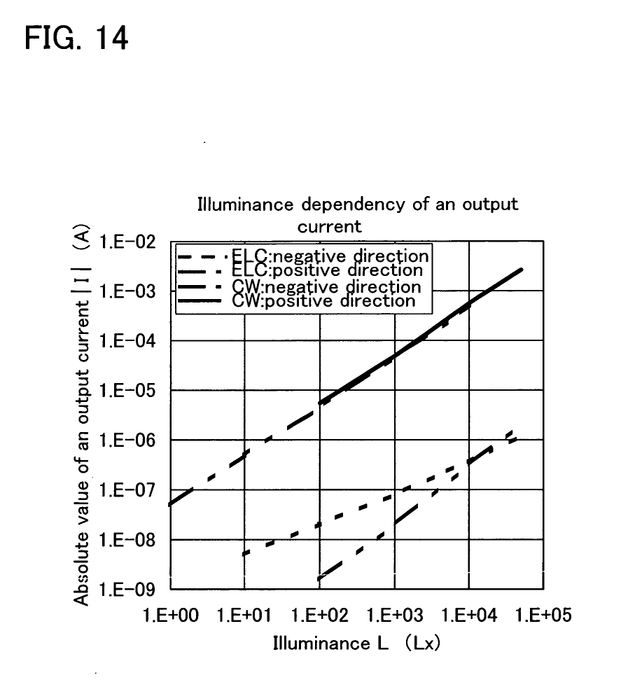

In this embodiment mode, current characteristics obtained when a bias applied to the photoelectric conversion device is reversed is described with reference to FIGS. 14 to 16.

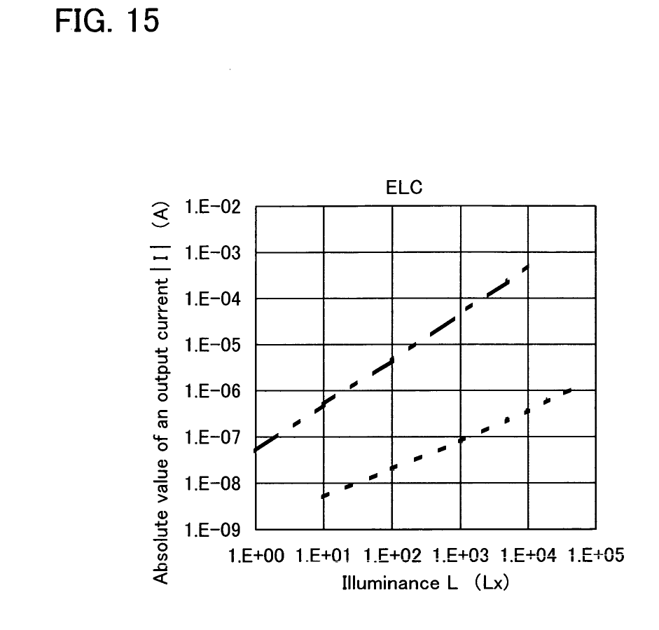

FIGS. 14 and 15 show illuminance dependency of an output current obtained when a bias is applied to the photoelectric conversion device.

In FIG. 14, ELC denotes illuminance dependency of an output current which is obtained from a photoelectric conversion device having a current mirror circuit formed by using a thin film transistor in which an island-shaped semiconductor region is crystallized by an excimer laser. Also, CW denotes illuminance dependency of an output current which is obtained from a photoelectric conversion device having a current mirror circuit formed by using a thin film transistor in which an island-shaped semiconductor region is crystallized by a continuous wave laser. In addition, a positive direction and a negative direction denote directions of a bias to be applied to a photoelectric conversion device. Note that FIG. 15 shows illuminance dependency in the case of ELC.

In accordance with FIG. 14, only when a bias of an opposite direction is applied, it is observed that there is a difference between an output current of a photoelectric conversion device which uses a thin film transistor having an island-shaped semiconductor region crystallized by an excimer laser and an output current of a photoelectric conversion device which uses a thin film transistor having an island-shaped semiconductor region crystallized by a continuous wave laser. This difference is derived from crystallinity of the island-shaped semiconductor regions in the thin film transistors. Further, this is because when a bias of a positive direction is applied, characteristics of a photoelectric conversion element is detected, and when a bias of a negative direction is applied, an open-circuit voltage Voc obtained from a photoelectric conversion element and illuminance of the light using characteristics of the thin film transistor are detected. Therefore, it is found that illuminance dependency of an output current obtained from a photoelectric conversion device can be changed depending on crystallinity of an island-shaped semiconductor region. Note that the illuminance dependency can also be changed depending on an S value of a thin film transistor or a threshold value of a thin film transistor, which is affected by crystallinity of an island-shaped semiconductor region. Accordingly, the photoelectric conversion device can have desired illuminance dependency. Thus, a photoelectric conversion device can be obtained, which has a light detecting function in accordance with a purpose and which can detect a wider range of illuminance by reversal of a bias to be applied to the photoelectric conversion device, without expansion of a range of an output voltage or output current.

In the case of ELC, for example, when a predetermined intensity by which a bias to be applied to a photoelectric conversion device is reversed is set to be 100 lx and a range of an output current is set to be 20 nA to 5 μA inclusive, the lower limit of a range of detectable illuminance can be approximately 0.5 lx and the upper limit thereof can be 100,000 lx or more. Therefore, a wider range of illuminance can be detected without expansion of a range of an output current.

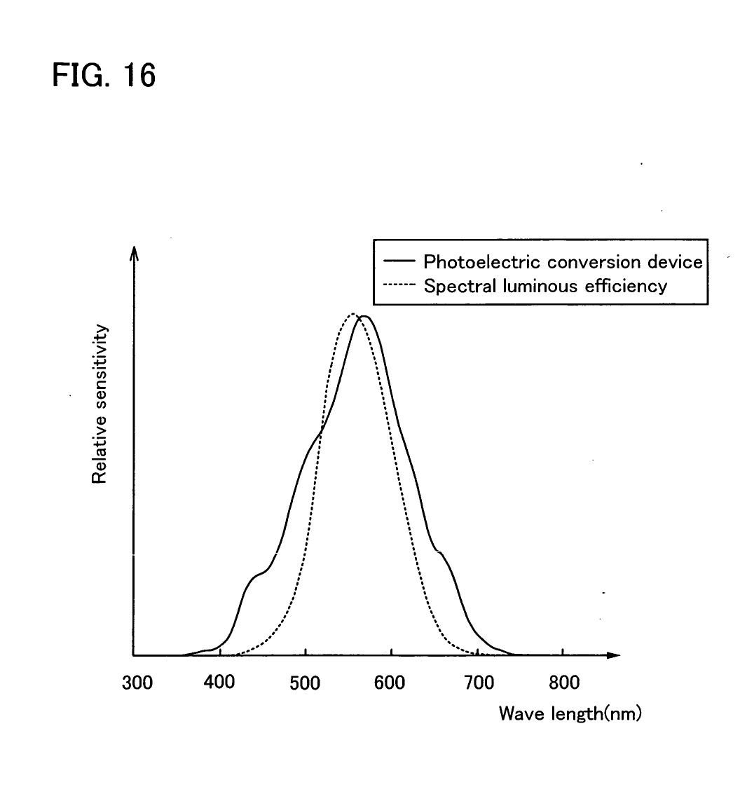

Note that FIG. 16 shows a relative sensitivity and a spectral luminous efficiency curve of the photoelectric conversion device which can be applied to a liquid crystal display device of the present invention. In accordance with FIG. 16, it is found that the relative sensitivity of the photoelectric conversion device is extremely close to the spectral luminous efficiency. Since spectral luminous efficacy close to that of human eyes can be obtained with the photoelectric conversion device, the performance of the photoelectric conversion device can be improved.

Although this embodiment mode is described with reference to various drawings, the contents (or a part thereof) described in each drawing can be freely applied to, combined with, or replaced with the contents (or a part thereof) described in another drawing. Further, even more drawings can be formed by combining each part with another part in the above-described drawings.

Similarly, the contents (or a part thereof) shown in each drawing of this embodiment mode can be freely applied to, combined with, or replaced with the contents (or a part thereof) described in a drawing in another embodiment mode. Further, even more drawings can be formed by combining each part with part of another embodiment mode in the drawings of this embodiment mode.

Note that this embodiment mode shows an example of an embodied case of the contents (or a part thereof) described in other embodiment modes, an example of slight transformation thereof, an example of partial modification thereof, an example of improvement thereof, an example of detailed description thereof, an application example thereof, an example of related part thereof, or the like. Therefore, the contents described in other embodiment modes can be freely applied to, combined with, or replaced with this embodiment mode.

### Embodiment Mode 5

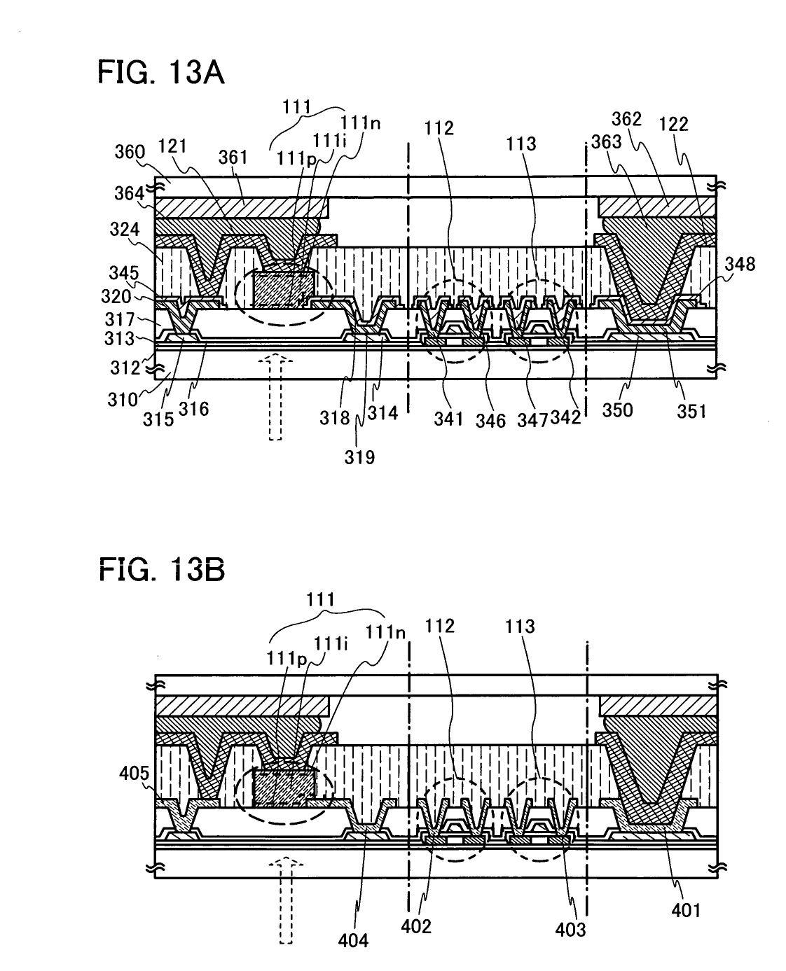

In this embodiment mode, description is made of a photoelectric conversion device of the present invention which can be applied to a liquid crystal display is applied and a manufacturing method of the photoelectric conversion device. Note that each of FIGS. 13A and 13B, and 17A to 18C shows an example of a partial cross sectional view of a photoelectric conversion device, and description is made with reference to the drawings.

First, an element is formed over a substrate (first substrate 310). In this embodiment mode, AN 100, which is one of glass substrates, is used as the substrate 310.

Subsequently, a silicon oxide film containing nitrogen (with a film thickness of 100 nm) to be the base insulating film 312 is formed by a plasma CVD method, and a semiconductor film such as an amorphous silicon film containing hydrogen (with a film thickness of 54 nm) is stacked thereover without being exposed to an atmospheric air. Note that the base insulating film 312 may be formed by stacking a silicon oxide film, a silicon nitride film, and a silicon oxide film containing nitrogen. For example, a film in which a silicon nitride film containing oxygen with a film thickness of 50 nm and a silicon oxide film containing nitrogen with a film thickness of 100 nm are stacked may be formed as the base insulating film 312. Note that the silicon oxide film containing nitrogen and the silicon nitride film serve as a blocking layer that prevents an impurity such as an alkali metal from diffusing from the glass substrate.

Then, the amorphous silicon film is crystallized by a solid-phase growth method, a laser crystallization method, a crystallization method using a catalytic metal, or the like to form a semiconductor film having a crystalline structure (a crystalline semiconductor film), for example, a polycrystalline silicon film. Here, a polycrystalline silicon film is obtained by a crystallization method using a catalytic element. A nickel acetate solution containing nickel of 10 ppm by weight is applied by a spinner. Note that a nickel element may be dispersed over the entire surface by a sputtering method instead of application of the solution. Then, heat treatment is performed for crystallization to form a semiconductor film having a crystalline structure. Here, a polycrystalline silicon film is obtained by heat treatment for crystallization (at 550° C. for 4 hours) after the heat treatment (at 500° C. for one hour).

Next, an oxide film over the surface of the polycrystalline silicon film is removed by a dilute hydrofluoric acid or the like. After that, in order to increase a crystallization rate in the polycrystalline silicon film and repair defects left in crystal grains, irradiation with laser light (XeCl: wavelength of 308 nm) is performed in the atmosphere or the oxygen atmosphere.

As the laser light, excimer laser light with a wavelength of 400 nm or less; or a second harmonic or a third harmonic of a YAG laser is used. Here, pulsed laser light with a repetition frequency of approximately 10 to 1000 Hz is used, the pulsed laser light is condensed to 100 to 500 MJ/cm² by an optical system, and irradiation is performed with an overlap rate of 90 to 95%, whereby the surface of the silicon film may be scanned. In this embodiment mode, irradiation with laser light having a repetition frequency of 30 Hz and energy density of 470 mJ/cm² is performed in the atmosphere.

Note that since laser light irradiation is performed in an atmospheric air or in an oxygen atmosphere, an oxide film is formed on the surface by the laser light irradiation. Note that although an example in which the pulsed laser is used is shown in this embodiment mode, a continuous wave laser may be used instead. In order to obtain crystal with large grain size at the time of crystallization of a semiconductor film, it is preferable to use a solid laser which is capable of continuous oscillation and to apply the second to fourth harmonic of a fundamental wave. Typically, a second harmonic (532 nm) or a third harmonic (355 nm) of an Nd:YVO₄ laser (a fundamental wave of 1064 nm) may be applied.

In the case of using a continuous wave laser, laser light which is emitted from a continuous wave YVO₄ laser of 10 W output is converted into a harmonic by a non-linear optical element. Alternatively, there is a method by which YVO₄ crystal and a non-linear optical element are put in a resonator and a high harmonic is emitted. Then, the laser light having a rectangular shape or an elliptical shape on an irradiated surface is preferably formed by an optical system to be emitted to an object to be processed. At this time, a power density of approximately 0.01 to 100 MW/cm² (preferably, 0.1 to 10 MW/cm²) is necessary. Then, the semiconductor film may be moved at a rate of approximately 10 to 2000 cm/s relatively to the laser light so as to be irradiated.

Subsequently, in addition to the oxide film which is formed by the above laser light irradiation, a barrier layer formed of an oxide film having a thickness of 1 to 5 nm in total is formed by treatment to the surface with ozone water for 120 seconds. The barrier layer is formed in order to remove the catalytic element which is added for crystallization, for example, nickel (Ni), from the film. Although the barrier layer is formed using ozone water here, the barrier layer may be formed by deposition of an oxide film having a thickness of approximately 1 to 10 nm by a method of oxidizing a surface of the semiconductor film having a crystalline structure by UV-ray irradiation in an oxygen atmosphere; a method of oxidizing a surface of the semiconductor film having a crystalline structure by oxygen plasma treatment; a plasma CVD method; a sputtering method; an evaporation method; or the like. Note that the oxide film formed by the laser light irradiation may be removed before formation of the barrier layer.

Then, an amorphous silicon film containing an argon element which serves as a gettering site is formed to be 10 to 400 nm thick, here 100 nm thick, over the barrier layer by a sputtering method. Here, the amorphous silicon film containing an argon element is formed under an atmosphere containing argon with the use of a silicon target. In a case where an amorphous silicon film containing an argon element is formed by a plasma CVD method, deposition conditions are as follows: a flow ratio of monosilane to argon (SiH₄:Ar) is 1:99, deposition pressure is set to be 6.665 Pa, RF power density is set to be 0.087 W/cm², and deposition temperature is set to be 350° C.

Thereafter, heat treatment in a furnace heated at 650° C. is performed for 3 minutes to remove a catalytic element (gettering). Accordingly, the catalytic element concentration in the semiconductor film having a crystalline structure is reduced. A lamp annealing apparatus may be used instead of the furnace.

Subsequently, the amorphous silicon film containing an argon element, which is a gettering site, is selectively removed using the barrier layer as an etching stopper, and thereafter, the barrier layer is selectively removed with a diluted hydrofluoric acid. Note that nickel has a tendency to move to a region having high oxygen concentration at the time of gettering; therefore, it is preferable that the barrier layer formed of an oxide film is removed after gettering.

Note that, in a case where the semiconductor film is not crystallized with the use of a catalytic element is not performed to a semiconductor film, the above steps such as forming the barrier layer, forming the gettering site, heat treatment for gettering, removing the gettering site, and removing the barrier layer are not necessary.

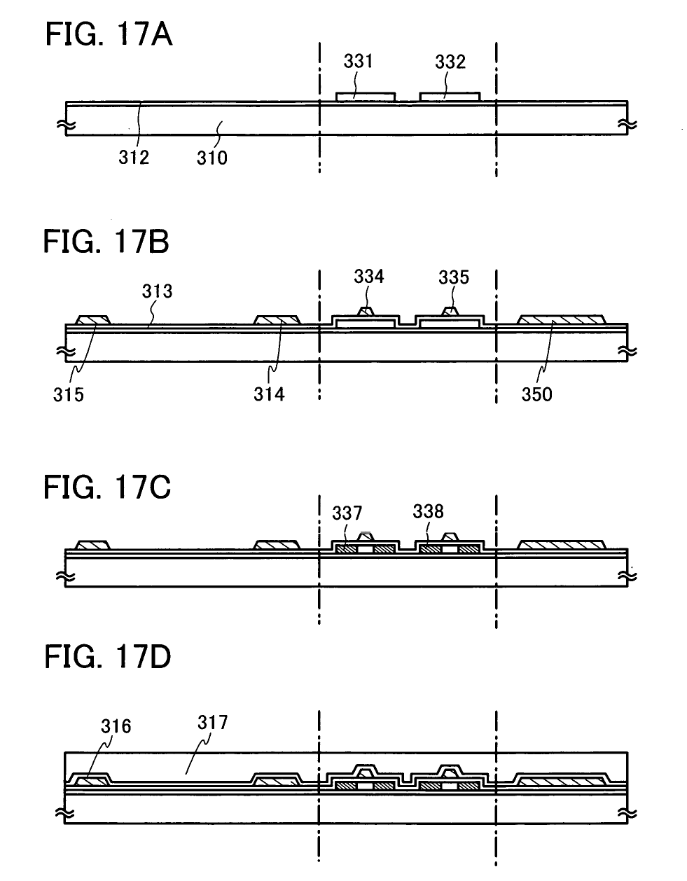

Subsequently, a thin oxide film is formed on the surface of the obtained semiconductor film having a crystalline structure (for example, a crystalline silicon film) with ozone water, and thereafter, a mask is formed of a resist using a first photomask and the semiconductor film is etched into a desired shape to form island-shaped semiconductor regions 331 and 332 that are semiconductor films each separated into an island shape (see FIG. 17A). After the island-shaped semiconductor regions are formed, a mask is formed of a resist is removed.

Next, a very small amount of an impurity element (boron or phosphorus) is added in order to control a threshold value of a thin film transistor, if necessary. Here, an ion doping method is used, in which diborane (B₂H₆) is not separated by mass but excited by plasma.

Subsequently, the oxide film is removed with an etchant containing a hydrofluoric acid, and at the same time, the surfaces of the island-shaped semiconductor regions 331 and 332 are washed. Thereafter, an insulating film containing silicon as its main component, which becomes a gate insulating film 313, is formed. Here, a silicon oxide film containing nitrogen (composition ratio: Si=32%, 0=59%, N=7%, and H=2%) is formed to have a thickness of 115 nm by a plasma CVD method.

Subsequently, after a metal film is formed over the gate insulating film 313, the metal film is processed using a second photomask to form gate electrodes 334 and 335, wirings 314 and 315, and a terminal electrode 350 (see FIG. 17B). As the metal film, for example, a film is used, in which tantalum nitride and tungsten (W) are stacked to be 30 nm and 370 nm respectively.

Additionally, as the gate electrodes 334 and 335, the wirings 314 and 315, and the terminal electrode 350, instead of the above film, a single-layer film formed from an element selected from titanium (Ti), tungsten (W), tantalum (Ta), molybdenum (Mo), neodymium (Nd), cobalt (Co), zirconium (Zr), zinc (Zn), ruthenium (Ru), rhodium (Rh), palladium (Pd), osmium (Os), iridium (Ir), platinum (Pt), aluminum (Al), gold (Au), silver (Ag), and copper (Cu), or an alloy material or a compound material containing the above element as its main component; a single-layer film formed from nitride thereof, for example, titanium nitride, tungsten nitride, tantalum nitride or molybdenum nitride; or a stacked-layer film of them may be used.

Subsequently, an impurity imparting one conductivity type is introduced to the island-shaped semiconductor regions 331 and 332 to form a source region and a drain region 337 of the thin film transistor 112 and a source region and a drain region 338 of the thin film transistor 113. In this embodiment mode, an n-channel thin film transistor is formed; therefore, an n-type impurity, for example, phosphorus (P) or arsenic (As) is introduced to the island-shaped semiconductor regions 331 and 332.

Next, a first interlayer insulating film (not shown) including a silicon oxide film is formed to be 50 nm thick by a CVD method, and thereafter, a step is performed, in which the impurity element added to each of the island-shaped semiconductor regions is activated. This activation process is performed by a rapid thermal annealing method (RTA method) using a lamp light source; an irradiation method with a YAG laser or an excimer laser from the back side of the substrate 310; heat treatment using a furnace; or a method which is a combination of any of the foregoing methods.

Then, a second interlayer insulating film 316 including a silicon nitride film containing hydrogen and oxygen is formed, for example, to be 10 nm thick. Subsequently, a third interlayer insulating film 317 formed of an insulating material is formed over the second interlayer insulating film 316 (see FIG. 17D). An insulating film obtained by a CVD method can be used for the third interlayer insulating film 317. In this embodiment mode, in order to improve fixing intensity, a silicon oxide film containing nitrogen is formed to be 900 nm thick as the third interlayer insulating film 317.

Then, heat treatment (heat treatment at 300 to 550° C. for 1 to 12 hours, for example, at 410° C. for 1 hour in a nitrogen atmosphere) is performed to hydrogenate the island-shaped semiconductor films. This step is performed to terminate a dangling bond of the island-shaped semiconductor films by hydrogen contained in the second interlayer insulating film 316. The island-shaped semiconductor films can be hydrogenated regardless of whether or not the gate insulating film 313 is formed.

Note that as the third interlayer insulating film 317, an insulating film using siloxane and a stacked structure thereof may be used. Siloxane is composed of a skeleton structure of a bond of silicon (Si) and oxygen (O). An organic group containing at least hydrogen (such as an alkyl group or an aromatic hydrocarbon) is used as a substituent. Note that a fluoro group may be included as a substituent.

In a case where an insulating film using siloxane and a stacked structure thereof are used as the third interlayer insulating film 317, after formation of the second interlayer insulating film 316, heat treatment to hydrogenate the island-shaped semiconductor films can be performed, and then, the third interlayer insulating film 317 can be formed.

Subsequently, a mask is formed from a resist using a third photomask, and the first interlayer insulating film, the second interlayer insulating film 316, the third interlayer insulating film 317 and the gate insulating film 313 are selectively etched to form a contact hole. Then, a mask is formed of a resist is removed. Note that the third interlayer insulating film 317 may be formed if necessary. In a case where the third interlayer insulating film 317 is not formed, the first interlayer insulating film, the second interlayer insulating film 316, and the gate insulating film 313 are selectively etched after formation of the second interlayer insulating film 316 to form a contact hole.

Next, after formation of a metal stacked film by a sputtering method, a mask is formed from a resist using a fourth photomask, and then, the metal film is selectively etched to form a wiring 319, a connection electrode 320, a terminal electrode 351, a source electrode and a drain electrode 341 of the thin film transistor 112, and a source electrode and a drain electrode 342 of the thin film transistor 113. Then, a mask is formed of a resist is removed. Note that the metal film of this embodiment mode is a stacked-layer film with three films: a Ti film with a thickness of 100 nm, an Al film containing a very small amount of Si with a thickness of 350 nm, and a Ti film with a thickness of 100 nm.

In addition, in a case where each of the wiring 319, the connection electrode 320, the terminal electrode 351, the source electrode and the drain electrode 341 of the thin film transistor 112, and the source electrode and the drain electrode 342 of the thin film transistor 113 is formed of a single-layer conductive film, a titanium film (Ti film) is preferable in terms of heat resistance, conductivity, and the like. Instead of a titanium film, a single-layer film formed from an element selected from tungsten (W), tantalum (Ta), molybdenum (Mo), neodymium (Nd), cobalt (Co), zirconium (Zr), zinc (Zn), ruthenium (Ru), rhodium (Rh), palladium (Pd), osmium (Os), iridium (Ir) and platinum (Pt), or an alloy material or a compound material containing the above element as its main component; a single-layer film formed from nitride thereof, for example, titanium nitride, tungsten nitride, tantalum nitride, or molybdenum nitride; or a stacked-layer film of them may be used. The number of times of deposition can be reduced in the manufacturing process, by formation of each of the wiring 319, the connection electrode 320, the terminal electrode 351, the source electrode and the drain electrode 341 of the thin film transistor 112, and the source electrode and the drain electrode 342 of the thin film transistor 113 as a single-layer film.

The top gate thin film transistors 112 and 113 using a polycrystalline silicon film can be manufactured through the process described above. Note that S values of the thin film transistors 112 and 113 can be changed depending on crystallinity of the semiconductor film and an interfacial state between the semiconductor film and the gate insulating film.

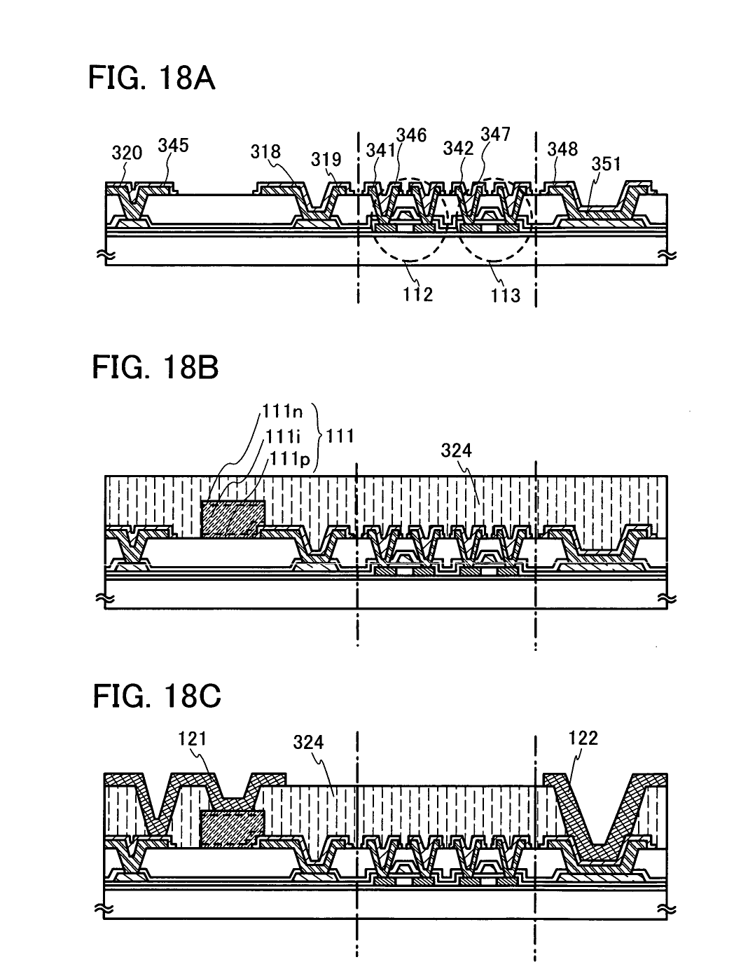

Subsequently, after formation of a conductive metal film (such as titanium (Ti) or molybdenum (Mo)) which is not likely to be an alloy by reacting with a photoelectric conversion layer (typically, amorphous silicon) which is formed later, a mask is formed from a resist using a fifth photomask, and then, the conductive metal film is selectively etched to form a protective electrode 318 which covers the wiring 319 (see FIG. 18A). Here, a Ti film having a thickness of 200 nm obtained by a sputtering method is used. Note that the connection electrode 320, the terminal electrode 351, and the source electrode and the drain electrode of the thin film transistor are covered with a conductive metal film similar to the protective electrode 318. Thus, the conductive metal film also covers a side face where the second Al film is exposed in these electrodes; therefore, the conductive metal film can also prevent diffusion of an aluminum atom to the photoelectric conversion layer.

Note that in a case where each of the wiring 319, the connection electrode 320, the terminal electrode 351, the source electrode and the drain electrode 341 of the thin film transistor 112, and the source electrode and the drain electrode 342 of the thin film transistor 113 are formed as a single-layer conductive film, that is, as shown in FIG. 13B, in a case where a wiring 404, a connection electrode 405, a terminal electrode 401, a source electrode and the drain electrode 402 of the thin film transistor 112, and the source electrode and a drain electrode 403 of the thin film transistor 113 are formed instead of these electrodes or wiring, the protective electrode 318 is not necessarily formed.

Subsequently, a photoelectric conversion layer 111 including a p-type semiconductor layer 111p, an i-type semiconductor layer 111i and an n-type semiconductor layer 111n is formed over the third interlayer insulating film 317.

The p-type semiconductor layer 111p may be formed by deposition of a semi-amorphous silicon film containing an impurity element belonging to Group 13 of the periodic table such as boron (B) by a plasma CVD method, or may be formed by introduction of an impurity element belonging to Group 13 after formation of the semi-amorphous silicon film.

Note that the protective electrode 318 is in contact with the bottom layer of the photoelectric conversion layer 111, in this embodiment mode, the p-type semiconductor layer 111p.

After the p-type semiconductor layer 111p is formed, the i-type semiconductor layer 111i and the n-type semiconductor layer 111n are sequentially formed. Accordingly, the photoelectric conversion layer 111 including the p-type semiconductor layer 111p, the i-type semiconductor layer 111i and the n-type semiconductor layer 111n is formed.

As the i-type semiconductor layer 111i, for example, a semi-amorphous silicon film may be formed by a plasma CVD method. Note that as the n-type semiconductor layer 111n, a semi-amorphous silicon film containing an impurity element belonging to Group 15, for example, phosphorus (P) may be formed, or after formation of a semi-amorphous silicon film, an impurity element belonging to Group 15 of the periodic table may be introduced.

Alternatively, as the p-type semiconductor layer 111p, the i-type semiconductor layer 111i and the n-type semiconductor layer 111n, an amorphous semiconductor film may be used as well as a semi-amorphous semiconductor film.

Next, a scaling layer 324 is formed from an insulating material (for example, an inorganic insulating film containing silicon) to have a thickness of 1 to 30 μM over the entire surface to obtain a state shown in FIG. 18B. Here, as an insulating material film, a silicon oxide film containing nitrogen with a thickness of 1 μm is formed by a CVD method. By using an inorganic insulating film, improvement in adhesiveness can be achieved.

Subsequently, after the sealing layer 324 is etched to provide an opening, terminals 121 and 122 are formed by a sputtering method. Each of the terminals 121 and 122 is a stacked-layer film of a titanium film (Ti film) (100 nm), a nickel film (Ni film) (300 nm), and a gold film (Au film) (50 nm). The thus obtained terminals 121 and 122 have a fixing intensity of higher than 5 N, which is sufficient fixing intensity as a terminal electrode.

Through the process described above, the terminals 121 and 122 which can be connected by a solder are formed, and a structure shown in FIG. 18C can be obtained.

Thus, a large number of photo IC chips (2 mm×1.5 mm each), that is, photoelectric conversion device chips can be manufactured from one large-sized substrate (for example, 600 cm×720 cm). Next, the substrate is cut into a plurality of photo IC chips.

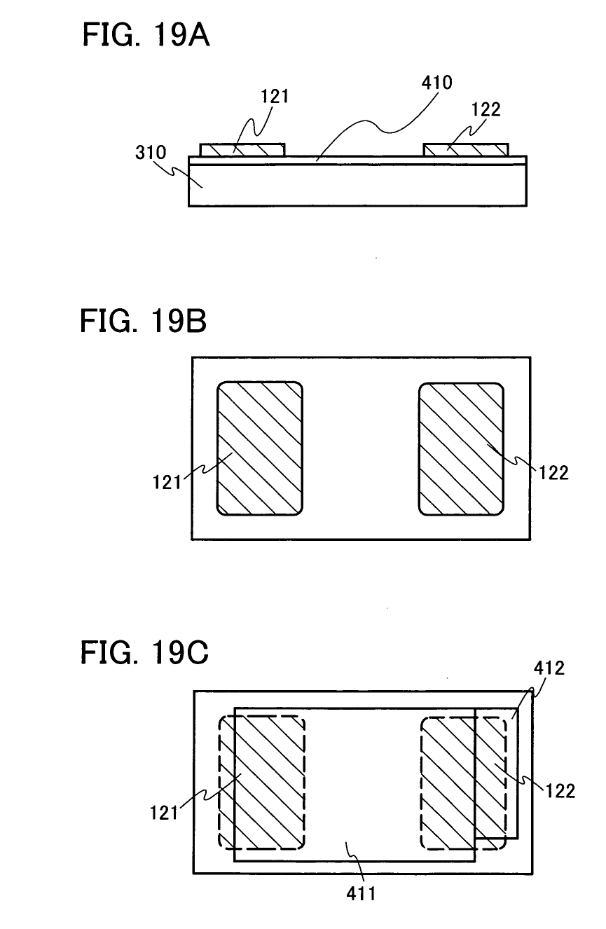

A cross-sectional view of one taken photo IC chip (2 mm×1.5 mm) is shown in FIG. 19A, a top view thereof is shown in FIG. 19B, and a bottom view thereof is shown in FIG. 19C. Note that the total thickness including thicknesses of a substrate 310, an element formation region 410, a terminal 121 and a terminal 122 is 0.8±0.05 mm in FIG. 19A.

In addition, in order to reduce the total thickness of a photoelectric conversion device, the substrate 310 may be ground to be thinned by CMP treatment or the like, and then, cut the substrate into by a dicer to take out a plurality of photoelectric conversion devices.

Note that in FIG. 19B, each electrode size of the terminals 121 and 122 is 0.6 mm×1.1 mm, and the interval between the electrodes is 0.4 mm. In addition, in FIG. 19C, the area of a light receiving portion 411 is 1.57 mm². Note that, an amplifier circuit portion 412 is provided with approximately 100 thin film transistors.

Lastly, the obtained photoelectric conversion device is mounted on a mounting surface of a substrate 360 (see FIG. 13A). Note that in order to connect the terminal 121 to an electrode 361 and the terminal 122 to an electrode 362, solders 364 and 363 are respectively used. The solders are formed in advance by a screen printing method or the like on the electrodes 361 and 362 of the substrate 360. Then, after the solder and the terminal electrode are made in an abutted state, solder reflow treatment is performed to mount the photoelectric conversion device on the substrate. The solder reflow treatment is performed at approximately 255 to 265° C. for about 10 seconds in an inert gas atmosphere, for example. Alternatively, a bump formed from a metal (such as gold or silver), a bump formed from a conductive resin, or the like can be used in addition to the solder. Further alternatively, a lead-free solder may be used for mounting in consideration of environmental problems.

In this manner, the photoelectric conversion device can be manufactured. Note that in order to detect the light, the light may be blocked using a housing or the like in a portion where the light does not enter the photoelectric conversion layer 111 from the substrate 310 side. Note that any material may be used for a housing as long as it has a function of blocking the light; for example, a housing may be formed using a metal material, a resin material having a black pigment, or the like. With such a structure, a photoelectric conversion device having a function of detecting the light which is more highly reliable can be manufactured.

In this embodiment mode, an example in which an amplifier circuit included in the photoelectric conversion device is formed using an n-channel thin film transistor is described. Alternatively, a p-channel thin film transistor may be used. Note that a p-channel thin film transistor can be formed similarly to an n-channel thin film transistor, when a p-type impurity such as boron (B) is used instead of an impurity imparting one conductivity type added to an island-shaped semiconductor region. Next, an example in which an amplifier circuit is formed using a p-channel thin film transistor is described.

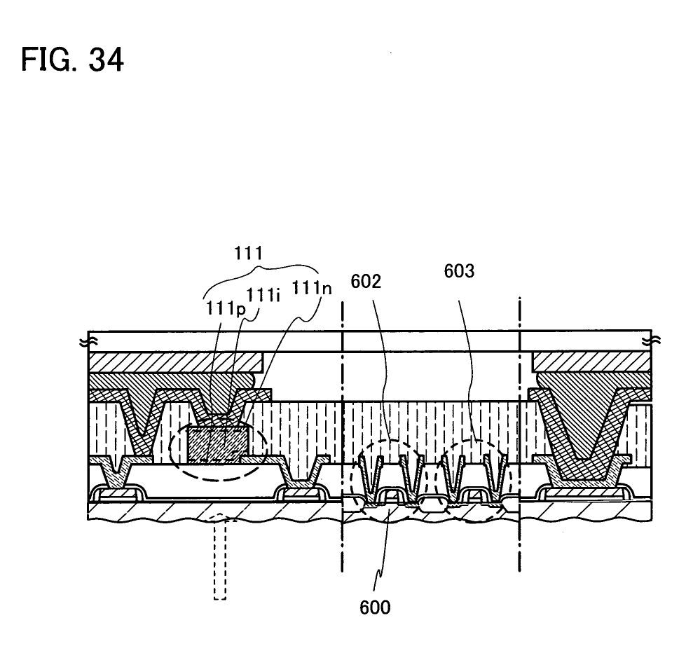

Additionally, FIG. 34 illustrates an example of manufacturing a photoelectric conversion device using a single crystal semiconductor substrate. In FIG. 34, transistors 602 and 603 are formed over the single crystal semiconductor substrate (a silicon substrate in FIG. 34). Transistors 602 and 603 are top-gate type transistors having insulating layers serving as side walls.

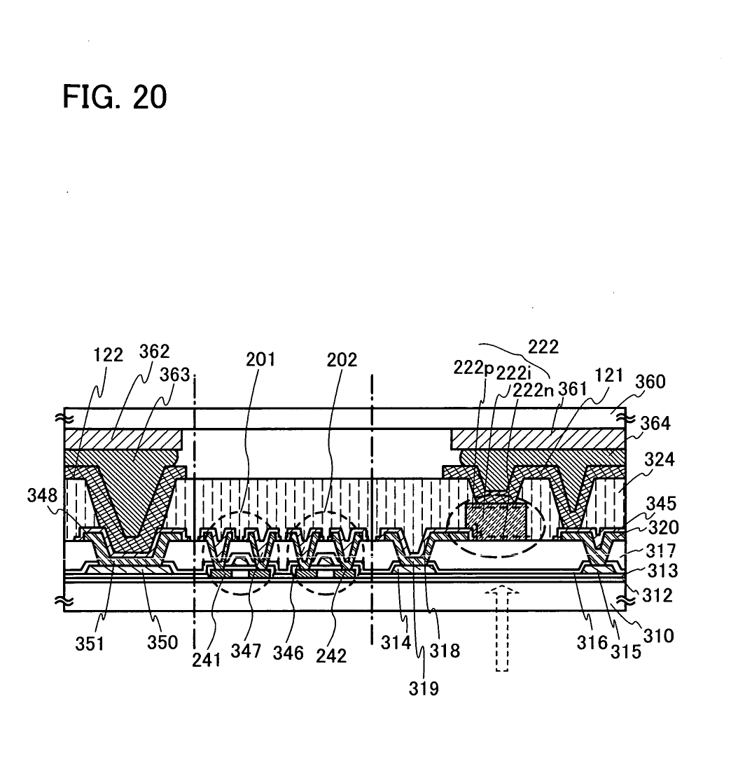

FIG. 20 shows a cross sectional view of a photoelectric conversion device in which an amplifier circuit such as a current mirror circuit is formed using a p-channel thin film transistor. FIG. 20 illustrates the p-channel thin film transistors 201 and 202, and a photoelectric conversion element. Note that the same portions as those in FIGS. 13A and 13B and portions having similar functions to those in FIGS. 13A and 13B are denoted by common reference numerals, and specific description thereof is omitted. As described above, a p-type impurity such as boron (B) is introduced into an island-shaped semiconductor region of the thin film transistor 201 and an island-shaped semiconductor region of the thin film transistor 202, and a source region and a drain region 241 and a source region and a drain region 242 are formed for the thin film transistor 201 and the thin film transistor 202 respectively. Further, a photoelectric conversion layer 222 included in the photoelectric conversion element has a structure where an n-type semiconductor layer 222n, an i-type semiconductor layer 222i, and a p-type semiconductor layer 222p are sequentially stacked. Note that the n-type semiconductor layer 222n, the i-type semiconductor layer 222i, and the p-type semiconductor layer 222p can be formed using similar materials and manufacturing methods to those of the n-type semiconductor layer 111n, the i-type semiconductor layer 111i, and the p-type semiconductor layer 111p, respectively.

Although this embodiment mode is described with reference to various drawings, the contents (or a part thereof) described in each drawing can be freely applied to, combined with, or replaced with the contents (or a part thereof) described in another drawing. Further, even more drawings can be formed by combining each part with another part in the above-described drawings.

Similarly, the contents (or a part thereof) shown in each drawing of this embodiment mode can be freely applied to, combined with, or replaced with the contents (or a part thereof) described in a drawing in another embodiment mode. Further, even more drawings can be formed by combining each part with part of another embodiment mode in the drawings of this embodiment mode.

Note that this embodiment mode shows an example of an embodied case of the contents (or a part thereof) described in other embodiment modes, an example of slight transformation thereof, an example of partial modification thereof, an example of improvement thereof, an example of detailed description thereof, an application example thereof, an example of related part thereof, or the like. Therefore, the contents described in other embodiment modes can be freely applied to, combined with, or replaced with this embodiment mode.

### Embodiment Mode 6

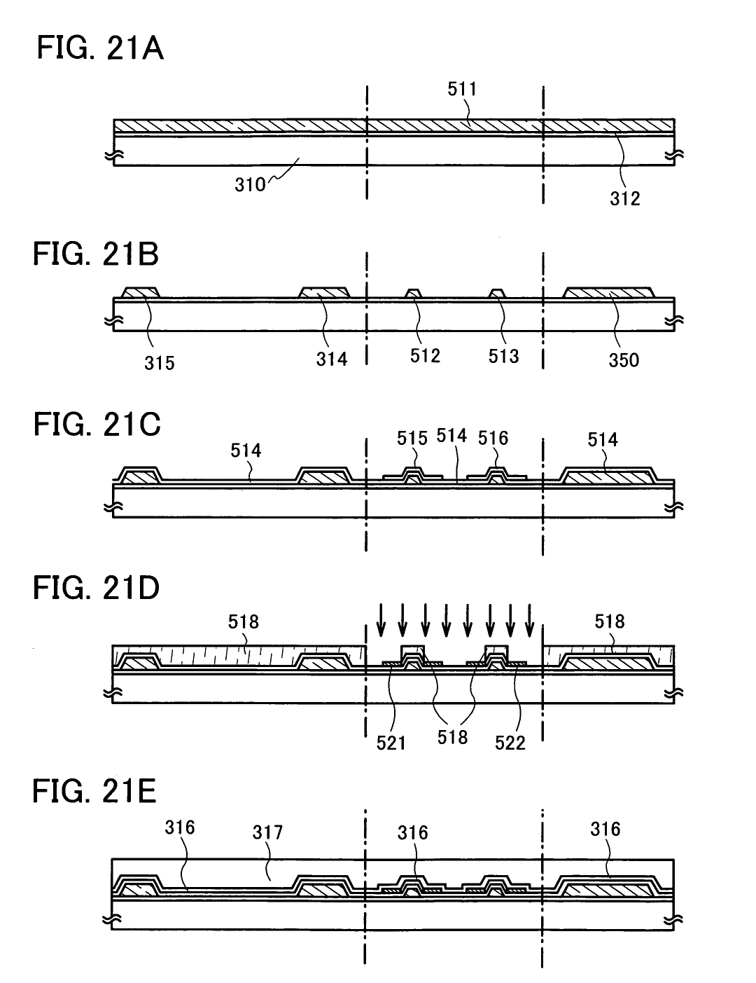

In this embodiment mode, an example of a photoelectric conversion device in which an amplifier circuit is formed using a bottom gate thin film transistor and a manufacturing method thereof is described with reference to FIGS. 21A to 23B.

First, a base insulating film 312 and a metal film 511 are formed over a substrate 310 (see FIG. 21A). As the metal film 511, in this embodiment mode, a stacked-layer film of tantalum nitride (TaN) having a thickness of 30 nm and tungsten (W) having a thickness of 370 nm is used, for example.

Note that as the metal film 511, instead of the above film, a single-layer film formed of an element selected from titanium (Ti), tungsten (W), tantalum (Ta), molybdenum (Mo), neodymium (Nd), cobalt (Co), zirconium (Zr), zinc (Zn), ruthenium (Ru), rhodium (Rh), palladium (Pd), osmium (Os), iridium (Ir), platinum (Pt), aluminum (Al), gold (Au), silver (Ag) and copper (Cu), or an alloy material or a compound material containing the above element as its main component; or a single-layer film formed from nitride thereof such as titanium nitride, tungsten nitride, tantalum nitride, or molybdenum nitride may be used.

Note that the metal film 511 may be formed directly on the substrate 310 without formation of the base insulating film 312 over the substrate 310.

Next, the metal film 511 is processed to form gate electrodes 512 and 513, wirings 314 and 315 and a terminal electrode 350 (see FIG. 21B).

Subsequently, a gate insulating film 514 which covers the gate electrodes 512 and 513, the wirings 314 and 315 and the terminal electrode 350 is formed. In this embodiment mode, the gate insulating film 514 is formed using an insulating film containing silicon as its main component, for example, a silicon oxide film containing nitrogen (composition ratio Si=32%, 0=59%, N=7%, H=2%) having a thickness of 115 nm by a plasma CVD method.

Next, island-shaped semiconductor regions 515 and 516 are formed over the gate insulating film 514. The island-shaped semiconductor regions 515 and 516 may be formed by the similar material and manufacturing process to those of the island-shaped semiconductor regions 331 and 332 described in Embodiment Mode 5 (see FIG. 21C).

After the island-shaped semiconductor regions 515 and 516 are formed, a mask 518 is formed to cover portions except for regions which become a source region and a drain region 521 of a thin film transistor 501 and a source region and a drain region 522 of a thin film transistor 502, and later, an impurity imparting one conductivity type is introduced (see FIG. 21D). As the one conductivity-type impurity, in a case of forming an n-channel thin film transistor, phosphorus (P) or arsenic (As) may be used as an n-type impurity, whereas in a case of forming a p-channel thin film transistor, boron (B) may be used as a p-type impurity. In this embodiment mode, phosphorus (P) which is an n-type impurity is introduced to the island-shaped semiconductor regions 515 and 516 to form the source region and the drain region 521 of the thin film transistor 501 and a channel formation region between these regions, and the source region and the drain region 522 of the thin film transistor 502 and a channel formation region between these regions. Note that a slight amount of an impurity element (boron or phosphorous) may be added to the channel formation region in order to control a threshold value of the thin film transistor, if necessary.

Next, the mask 518 is removed, and a first interlayer insulating film which is not shown, a second interlayer insulating film 316 and a third interlayer insulating film 317 are formed (see FIG. 21E). A material and a manufacturing process of the first interlayer insulating film, the second interlayer insulating film 316 and the third interlayer insulating film 317 may be based on the description in Embodiment Mode 5.

Contact holes are formed in the first interlayer insulating film, the second interlayer insulating film 316 and the third interlayer insulating film 317, and a metal film is formed, and further, the metal film is selectively etched to form the wiring 319, the connection electrode 320, the terminal electrode 351, a source electrode and a drain electrode 531 of the thin film transistor 501 and a source electrode and a drain electrode 532 of the thin film transistor 502. Then, a mask is formed of a resist is removed. Note that the metal film of this embodiment mode is a stacked-layer film including three layers: a Ti film having a thickness of 100 nm, an Al film containing a very small amount of silicon having a thickness of 350 nm, and a Ti film having a thickness of 100 nm.

In addition, instead of the wiring 319 and a protective electrode thereof 318; the connection electrode 320 and a protective electrode thereof 533; the terminal electrode 351 and a protective electrode thereof 538; the source electrode and the drain electrode 531 of the thin film transistor 501 and a protective electrode thereof 536; and the source electrode and the drain electrode 532 of the thin film transistor 502 and a protective electrode thereof 537, each wiring and electrode may be formed using a single-layer conductive film, in the same manner as the wiring 404, the connection electrode 405, the terminal electrode 401, the source electrode and the drain electrode 402 of the thin film transistor 112 and the source electrode and the drain electrode 403 of the thin film transistor 113 in FIG. 13B.

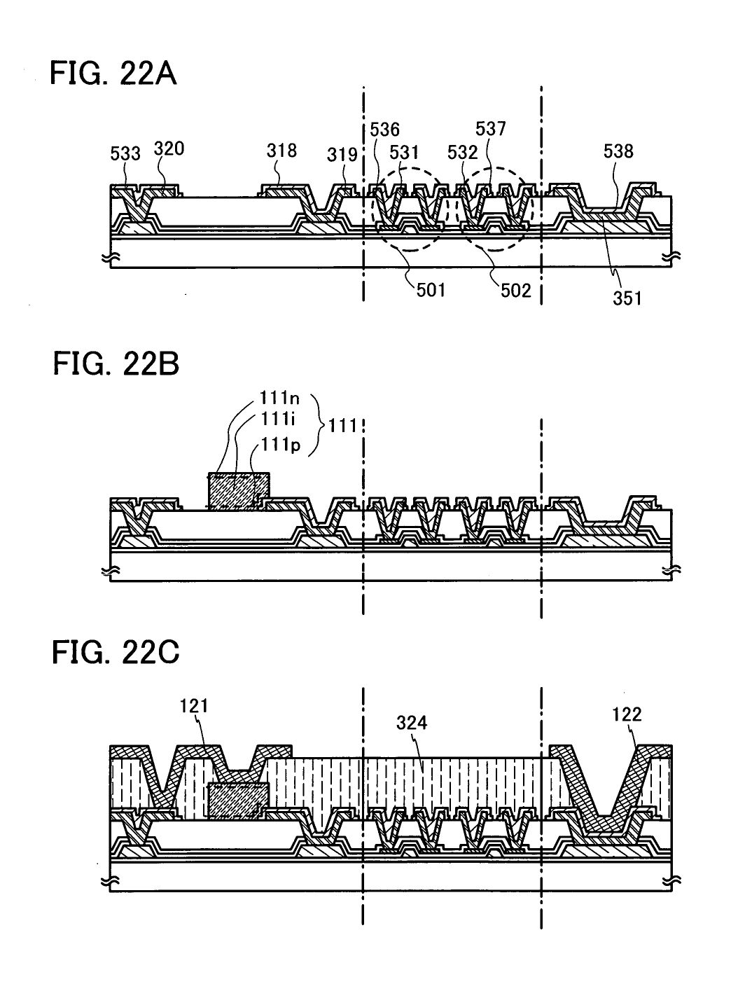

Through the above process, bottom gate thin film transistors 501 and 502 can be manufactured (see FIG. 22A).

Subsequently, the photoelectric conversion layer 111 including the p-type semiconductor layer 111p, the i-type semiconductor layer 111i and the n-type semiconductor layer 111n is formed over the third interlayer insulating film 317 (see FIG. 22B). A material, a manufacturing process and the like of the photoelectric conversion layer 111 may be based on the description in Embodiment Mode 5.

Next, the sealing layer 324 and the terminals 121 and 122 are formed (FIG. 22C). The terminal 121 is connected to the n-type semiconductor layer 111n, and the terminal 122 is formed in the same process as the terminal 121.

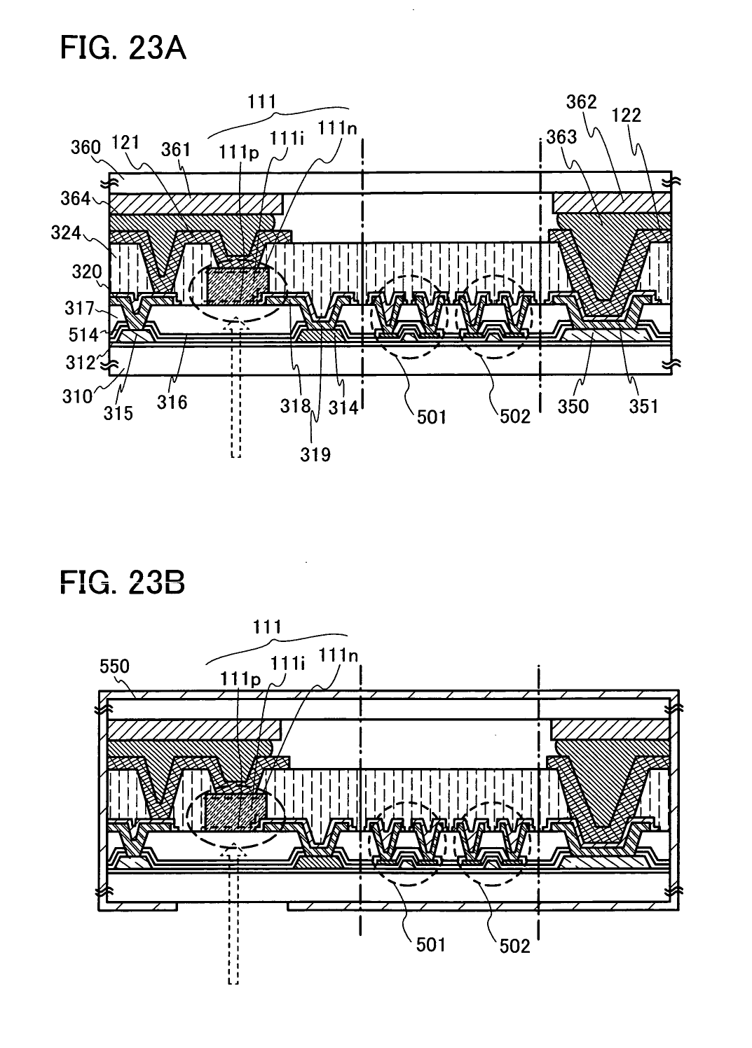

Moreover, the substrate 360 having the electrodes 361 and 362 is mounted using the solders 364 and 363. Note that the electrode 361 on the substrate 360 is mounted on the terminal 121 by the solder 364. In addition, the electrode 362 on the substrate 360 is mounted on the terminal 122 by the solder 363 (see FIG. 23A).

In a photoelectric conversion device shown in FIG. 23A, the light which enters the photoelectric conversion layer 111 enters mainly from the substrate 310 side; however, the present invention is not limited to this. Note that as shown in FIG. 23B, a housing 550 may be provided in a portion except a region where the photoelectric conversion layer 111 on the substrate 310 side is formed. Note that any material may be used for the housing 550 as long as it has a function of blocking the light; for example, the housing 550 may be formed using a metal material, a resin material having a black pigment, or the like. With such a structure, a highly reliable photoelectric conversion device having a function of detecting the light which is more reliable can be manufactured.

Although this embodiment mode is described with reference to various drawings, the contents (or a part thereof) described in each drawing can be freely applied to, combined with, or replaced with the contents (or a part thereof) described in another drawing. Further, even more drawings can be formed by combining each part with another part in the above-described drawings.

Similarly, the contents (or a part thereof) shown in each drawing of this embodiment mode can be freely applied to, combined with, or replaced with the contents (or a part thereof) described in a drawing in another embodiment mode. Further, even more drawings can be formed by combining each part with part of another embodiment mode in the drawings of this embodiment mode.

Note that this embodiment mode shows an example of an embodied case of the contents (or a part thereof) described in other embodiment modes, an example of slight transformation thereof, an example of partial modification thereof, an example of improvement thereof, an example of detailed description thereof, an application example thereof, an example of related part thereof, or the like. Therefore, the contents described in other embodiment modes can be freely applied to, combined with, or replaced with this embodiment mode.

### Embodiment Mode 7

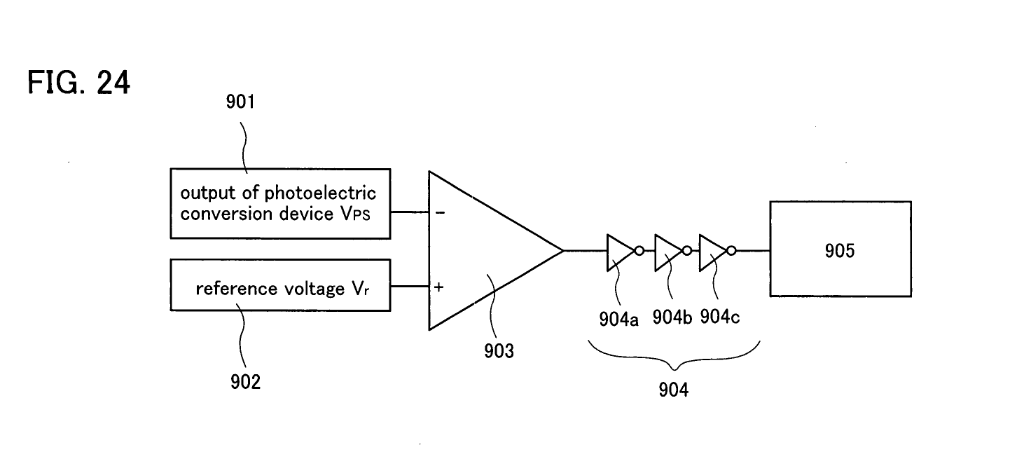

In this embodiment mode, a circuit which switches a bias is described as an example of the bias switching unit with reference to FIGS. 24 to 28B.

The circuit shown in FIG. 24 reverses a bias to be applied to the photoelectric conversion device when the output voltage, which is obtained by outputting the current obtained from the photoelectric conversion device as a voltage, reaches a certain value. In other words, the circuit reverses a bias at a predetermined level of illuminance. Note that the circuit shown in FIG. 24 reverses the bias in a case where the output voltage exceeds the reference voltage Vr serving as a boundary.

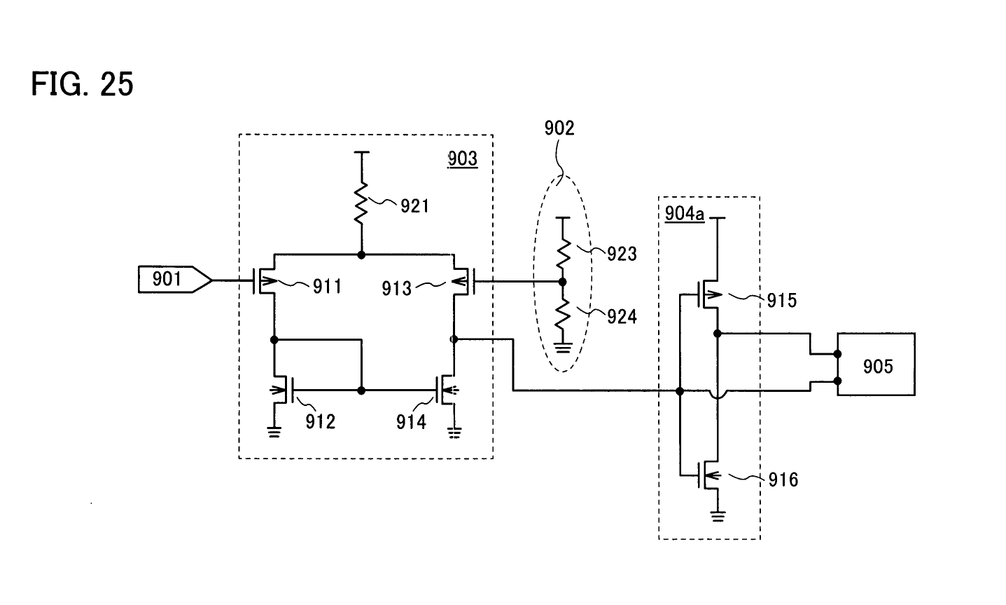

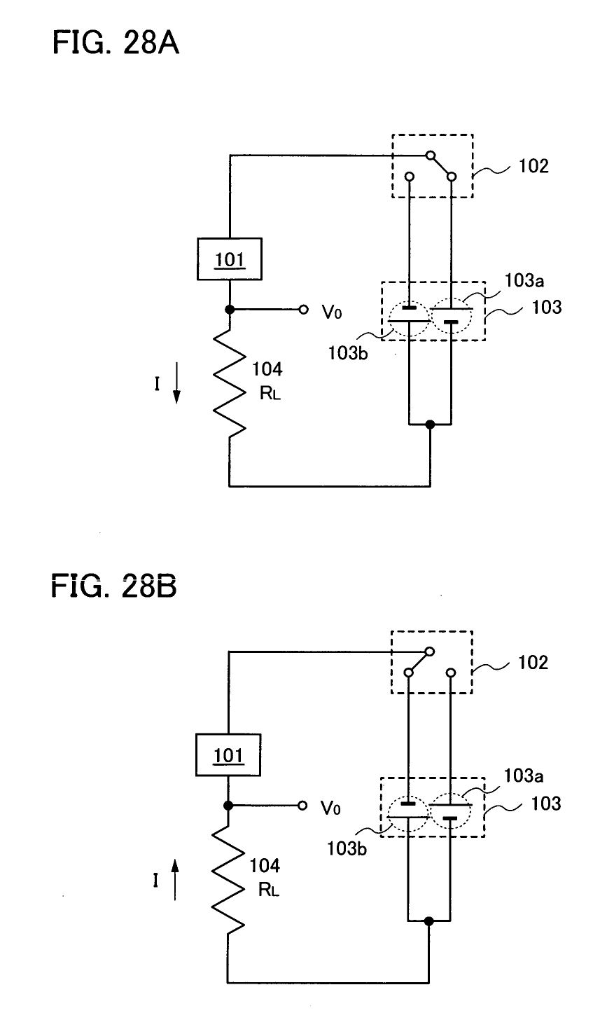

In FIGS. 24 and 25, reference numeral 901 denotes a output of photoelectric conversion device V_{PS}, 902 denotes a reference voltage generating circuit to determine the reference voltage Vr, 903 denotes a comparator, and 904 denotes an output buffer having a first stage 904a, a second stage 904b and a third stage 904c. Note that although only three stages of the output buffer are described here, four or more stages of the output buffer may be provided instead, or alternatively, only one stage of the output buffer may be provided. Further, the comparator 903 and the output buffer 904 correspond to the bias switching unit 102 and the power supply 103 in FIGS. 28A and 28B respectively, and reference numeral 905 corresponds to the photoelectric conversion element 101 and the resistor 104.

FIG. 25 shows a specific circuit configuration of FIG. 24, and the comparator 903 has p-channel thin film transistors 911 and 913, n-channel thin film transistors 912 and 914 and a resistor 921. Note that the reference voltage generating circuit 902 has resistors 923 and 924, and determines the reference voltage Vr by the resistors.

Note that in FIG. 25, only the first stage 904a of the output buffer 904 is shown, and the first stage 904a includes a p-channel thin film transistor 915 and an n-channel thin film transistor 916. Note that in FIG. 25, an n-channel thin film transistor is a single gate thin film transistor which has one gate electrode. However, in order to reduce an off current, the n-channel thin film transistor may be a multi gate thin film transistor which has a plurality of gate electrodes, for example, a double gate thin film transistor which has two gate electrodes. Note that the other stages may be formed with similar circuits to the first stage 904a.

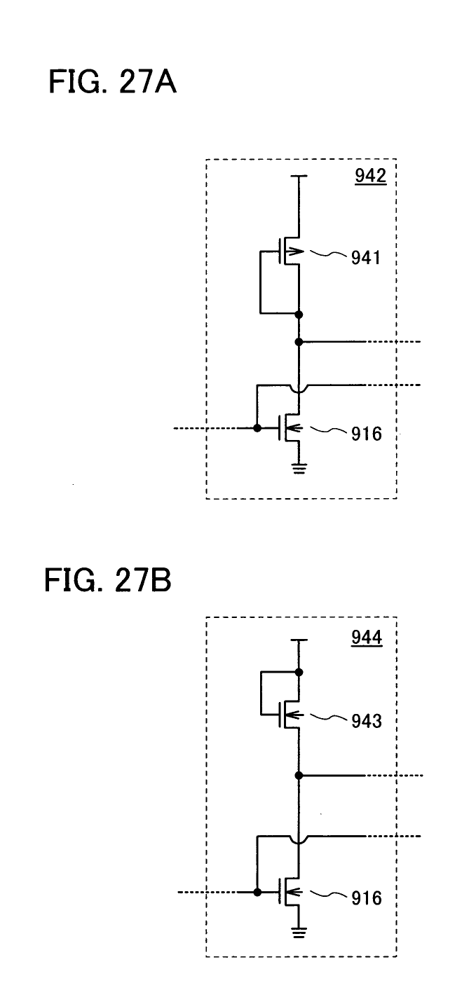

In FIG. 25, the one stage of the output buffer 904 may be substituted by a circuit 942 shown in FIG. 27A or a circuit 944 shown in FIG. 27B. The circuit 942 shown in FIG. 27A includes an n-channel thin film transistor 916 and a p-channel thin film transistor 941, and the circuit 944 shown in FIG. 27B includes n-channel thin film transistors 916 and 943.

Note that the output voltage, which is obtained by outputting the current obtained from the photoelectric conversion device as a voltage, may be used for the output of photoelectric conversion device V_{PS}, or a voltage obtained by amplifying the output voltage in an amplifier circuit may also be used.

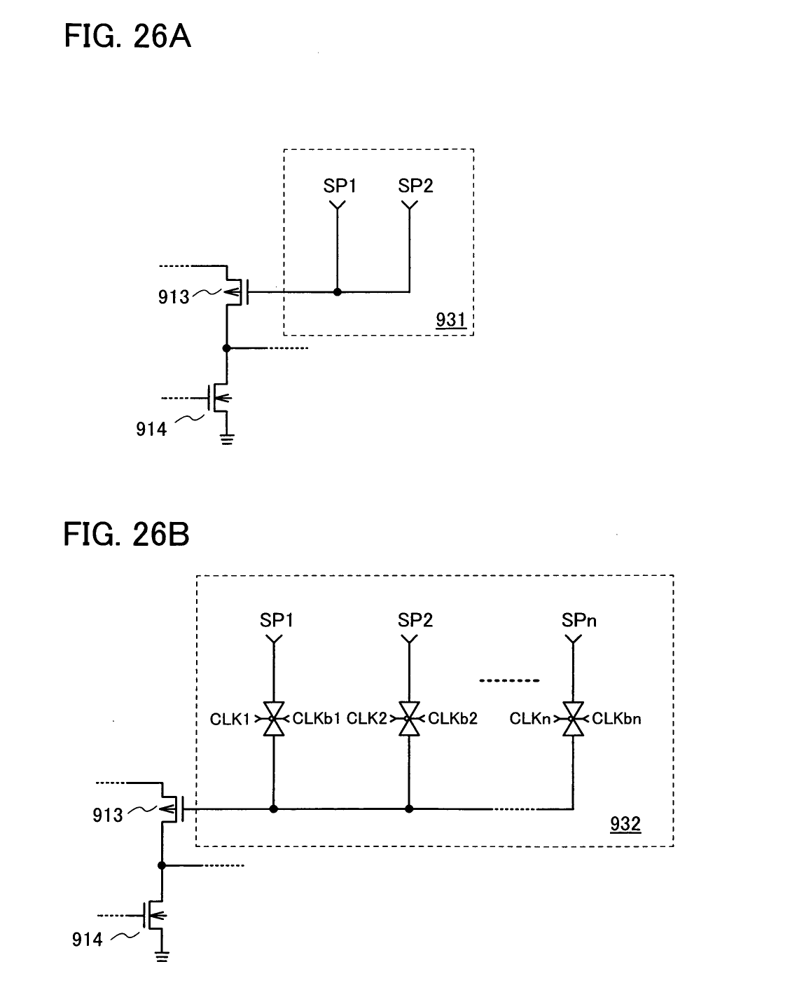

In FIGS. 28A and 28B, the reference voltage Vr is determined by the reference voltage generating circuit. In a case where other reference voltage is desired to be obtained, as shown in FIGS. 26A and 26B, the reference voltage Vr may be directly inputted from an external circuit 931 (see FIG. 26A), or inputted from a circuit 932 selecting several input voltages with use of a selector (an analog switch or the like) (see FIG. 26B).

Note that in the circuit shown in FIG. 25, the reference voltage Vr is necessary to be equal to or higher than a threshold voltage (Vth≦Vr is satisfied when the threshold voltage is Vth) of a thin film transistor which is included in the comparator. It is necessary that the reference voltage or the output of photoelectric conversion device V_{PS} be adjusted so as to meet this condition.

The output of photoelectric conversion device V_{PS} is inputted to the gate electrode of the p-channel thin film transistor 911 of the comparator 903, and is compared with a voltage value from the reference voltage generating circuit 902. In a case where the output of photoelectric conversion device VPs is lower than a voltage value from the reference voltage generating circuit, the output of photoelectric conversion device V_{PS} is connected to a power supply 103a of the power supply 103, and a current flows in a direction shown in FIG. 28A. Meanwhile, in a case where the output of photoelectric conversion device V_{PS} is higher than a voltage value from the reference voltage generating circuit, the output of photoelectric conversion device VPs is connected to a power supply 103b of the power supply 103, and a current flows in a direction shown in FIG. 28B.

By reversal of a bias to be applied to the photoelectric conversion device with the use of the bias switching unit described above, a wider range of illuminance can be detected without expansion of a range of an output voltage or output current.

Although this embodiment mode is described with reference to various drawings, the contents (or a part thereof) described in each drawing can be freely applied to, combined with, or replaced with the contents (or a part thereof) described in another drawing. Further, even more drawings can be formed by combining each part with another part in the above-described drawings.

Similarly, the contents (or a part thereof) shown in each drawing of this embodiment mode can be freely applied to, combined with, or replaced with the contents (or a part thereof) described in a drawing in another embodiment mode. Further, even more drawings can be formed by combining each part with part of another embodiment mode in the drawings of this embodiment mode.

Note that this embodiment mode shows an example of an embodied case of the contents (or a part thereof) described in other embodiment modes, an example of slight transformation thereof, an example of partial modification thereof, an example of improvement thereof, an example of detailed description thereof, an application example thereof, an example of related part thereof, or the like. Therefore, the contents described in other embodiment modes can be freely applied to, combined with, or replaced with this embodiment mode.

### Embodiment Mode 8

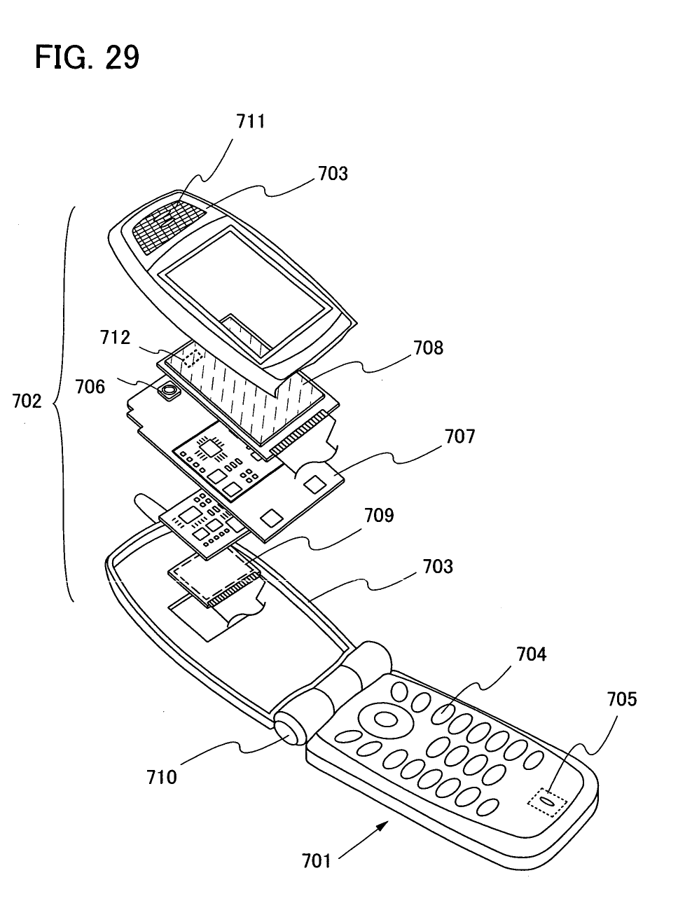

In this embodiment mode, an example in which a liquid crystal display device obtained by the present invention is incorporated in various electronic devices is described. As electronic devices to which the present invention is applied, a computer, a display, a mobile phone, a TV set and the like are given. Specific examples of those electronic devices are shown in FIGS. 29 to 31B.

FIG. 29 shows an example of a mobile phone to which the present invention is applied, and the mobile phone includes a main body (A) 701, a main body (B) 702, a housing 703, operation keys 704, an audio input portion 705, an audio output portion 706, a circuit substrate 707, a display panel (A) 708, a display panel (B) 709, a hinge 710, a light-transmitting material portion 711 and a photoelectric conversion device 712.

The photoelectric conversion device 712 detects the light entering from the housing 703 side. Then the photoelectric conversion device 712 controls luminance of the display panel (A) 708 and the display panel (B) 709 in accordance with illuminance of the detected external light, or controls illumination of the operation keys 704 in accordance with illuminance obtained by the photoelectric conversion device 712. Accordingly, power consumption of the mobile phone can be reduced.

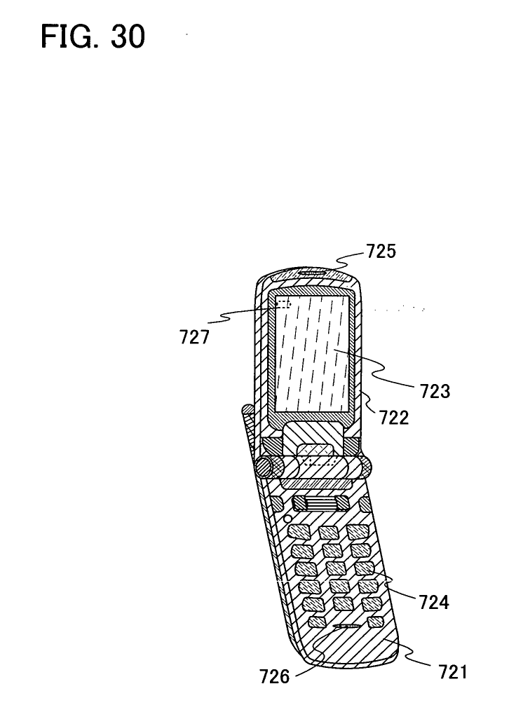

FIG. 30 shows another example of a mobile phone which is different from the above example. In FIG. 30, reference numeral 721 denotes a main body, 722 denotes a housing, 723 denotes a display panel, 724 denotes operation keys, 725 denotes an audio output portion, 726 denotes an audio input portion, and 727 denotes a photoelectric conversion device.

In the mobile phone shown in FIG. 30, the luminance of the display panel 723 can be controlled by detecting the light from the exterior with the photoelectric conversion device 727. Further, luminance of the backlight device provided for the display panel 723 can be detected and the luminance of the display panel can be controlled. Therefore, power consumption can be reduced.

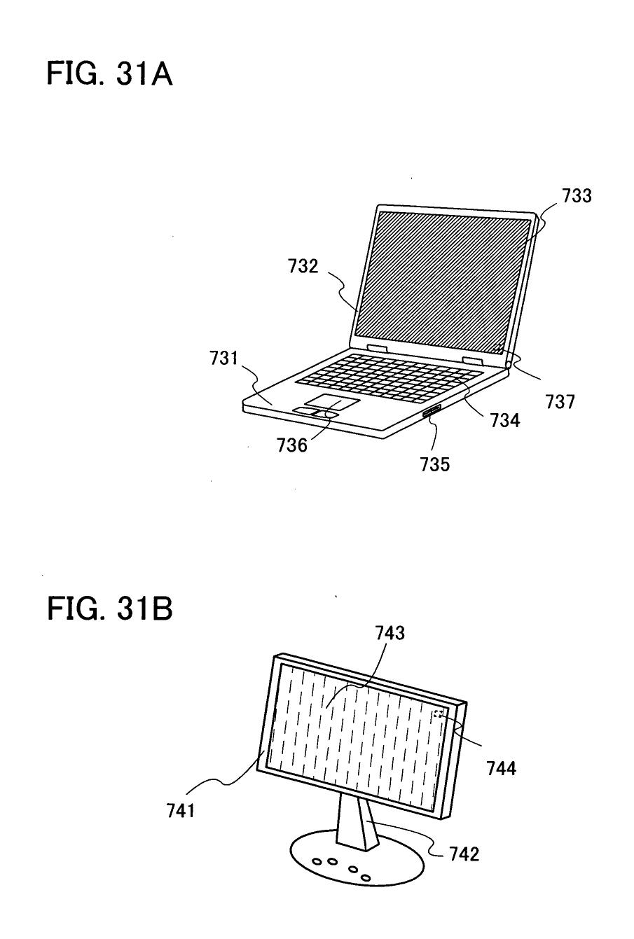

FIG. 31A shows a computer including a main body 731, a housing 732, a display portion 733, a keyboard 734, an external connection port 735, a pointing device 736, a photoelectric conversion device 737, and the like. The photoelectric conversion device 737 detects brightness of surroundings and gives feedback on the data so that the luminance of the display portion 733 (or the luminance of backlight device) is controlled.

FIG. 31B shows a display device, and corresponds to a television receiver or the like. The display device includes a housing 741, a supporting base 742, a display portion 743, a photoelectric conversion device 744 and the like. The photoelectric conversion device 744 detects brightness of surroundings and gives feedback on the data so that the luminance of the display portion 743 (or the luminance of the backlight device) is controlled.

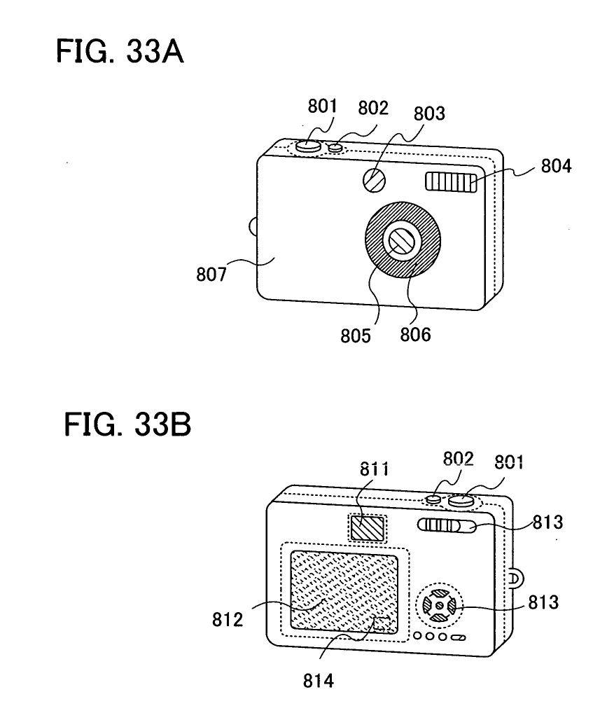

FIGS. 33A and 33B are views each showing an example in which the liquid crystal display device of the present invention is incorporated in a camera such as a digital camera. FIG. 33A is a front perspective view of the digital camera, and FIG. 33B is a back perspective view of the digital camera. In FIG. 33A, the digital camera is provided with a release button 801, a main switch 802, a viewfinder 803, a flush portion 804, a lens 805, a lens barrel 806, and a housing 807. In addition, in FIG. 33B, a viewfinder eyepiece 811, a monitor 812, operation buttons 813 and a photoelectric conversion device 814 are provided.

When the release button 801 is pressed down halfway, a focusing adjusting mechanism and an exposure adjusting mechanism are operated, and when the release button is pressed down fully, a shutter is opened. The main switch 802 switches ON or OFF of a power supply of a digital camera by being pressed or rotated. The viewfinder 803 is placed at the upper portion of the lens 805 of a front side of the digital camera, and is a device for recognizing an area which is taken or a focus position from the viewfinder eyepiece 811 shown in FIG. 33B. The flush portion 804 is placed at the upper portion of the front side of the digital camera, and when object luminance is low, supporting light is emitted at the same time as the release button is pressed down so that the shutter is opened. The lens 805 is placed at the front face of the digital camera. The lens is formed of a focusing lens, a zoom lens, or the like, and forms a photographing optical system with a shutter and aperture that are not shown. Note that an image pickup device such as CCD (Charge Coupled Device) is provided at the rear of the lens. The lens barrel 806 moves a lens position to adjust the focus of the focusing lens, the zoom lens, and the like. When shooting, the lens barrel is slid out to move the lens 805 forward. In addition, when carrying the camera, the lens 805 is moved backward so as to make the camera compact. Note that a structure is employed in this embodiment mode, in which the lens barrel is slid out so that the object can be shot by being zoomed; however, the present invention is not limited thereto. Instead, a digital camera may employ a structure in which zoom shooting can be conducted without sliding out the lens barrel by a photographing optical system inside the housing 807. The viewfinder eyepiece 811 is provided at the upper portion of the rear side of the digital camera, for looking through when checking an area which is taken or a focus point. The operation buttons 813 are buttons for various functions that are provided at the rear side of the digital camera and include a set up button, a menu button, a display button, a functional button, a selection button and the like.

When the photoelectric conversion device 814 is incorporated in the camera shown in FIGS. 33A and 33B, the photoelectric conversion device 814 can detect the light intensity and whether or not light exists, and accordingly, an exposure adjustment or the like of the camera can be performed. The photoelectric conversion device 814 detects brightness of surroundings and gives feedback on the data so that the luminance of a monitor 812 (or the luminance of backlight device) is controlled.

In addition, the liquid crystal display device of the present invention can be applied to other electronic devices such as a projection TV and a navigation system. That is, the liquid crystal display device of the present invention can be used for any device which is necessary to detect the light. A result of the light detection is fed back, whereby power consumption can be reduced.

Although this embodiment mode is described with reference to various drawings, the contents (or a part thereof) described in each drawing can be freely applied to, combined with, or replaced with the contents (or a part thereof) described in another drawing. Further, even more drawings can be formed by combining each part with another part in the above-described drawings.

Similarly, the contents (or a part thereof) shown in each drawing of this embodiment mode can be freely applied to, combined with, or replaced with the contents (or a part thereof) described in a drawing in another embodiment mode. Further, even more drawings can be formed by combining each part with part of another embodiment mode in the drawings of this embodiment mode.

Note that this embodiment mode shows an example of an embodied case of the contents (or a part thereof) described in other embodiment modes, an example of slight transformation thereof, an example of partial modification thereof, an example of improvement thereof, an example of detailed description thereof, an application example thereof, an example of related part thereof, or the like. Therefore, the contents described in other embodiment modes can be freely applied to, combined with, or replaced with this embodiment mode.

This application is based on Japanese Patent Application serial No. 2006-352691 filed with Japan Patent Office on Dec. 27, 2006, the entire contents of which are hereby incorporated by reference.

What is claimed is:

1. A liquid crystal display device comprising:
a photoelectric conversion device;
a liquid crystal panel provided with a pixel portion and a peripheral portion of the pixel portion; and
a backlight device,
wherein the photoelectric conversion device is provided between the backlight device and the liquid crystal panel.

2. The liquid crystal display device according to claim 1, wherein the photoelectric conversion device comprises a sensor and a driver portion, and
wherein the sensor is provided between the backlight device and the pixel portion.

3. The liquid crystal display device according to claim 2, wherein the driver portion is provided between the backlight device and the peripheral portion of the pixel portion.

4. The liquid crystal display device according to claim 1, further a circuit on the peripheral portion of the pixel portion, the circuit being formed over a single crystalline substrate.

5. The liquid crystal display device according to claim 1, further comprising a circuit on the peripheral portion of the pixel portion, the circuit being formed over a same substrate as the pixel portion.

6. A liquid crystal display device comprising:
a photoelectric conversion device comprising a sensor and a driver portion;
a liquid crystal panel provided with a pixel portion; and
a backlight device,
wherein the pixel portion includes a light-transmitting region and a light-shielding region, and
wherein the sensor is provided between the backlight device and the light-transmitting region.

7. The liquid crystal display device according to claim 6, wherein the driver portion is provided between the backlight device and the light-shielding region.

8. The liquid crystal display device according to claim 6, further comprising a wiring provided in the light-shielding region.

9. The liquid crystal display device according to claim 6, further comprising a transistor provided in the light-shielding region.

10. The liquid crystal display device according to claim 6, further comprising a black matrix provided in the light-shielding region.

11. A liquid crystal display device comprising:
a photoelectric conversion device comprising a sensor and a driver portion;
a liquid crystal panel provided with a pixel portion; and
a backlight device,
wherein the pixel portion includes a light-transmitting region and a reflective region, and
wherein the sensor is provided between the backlight device and the light-transmitting region.

12. The liquid crystal display device according to claim 11, wherein the driver portion is provided between the backlight device and the reflective region.

13. The liquid crystal display device according to claim 11, wherein a first pixel electrode having a light-transmitting property is provided in the light-transmitting region, and wherein a second pixel electrode having a reflective property is provided in the reflective region.

14. A liquid crystal display device comprising:
a liquid crystal panel;
a control circuit operationally connected to the liquid crystal panel;
a backlight device operationally connected to the control circuit; and
a photoelectric conversion device operationally connected to the control circuit and being capable of detecting external light passing through the liquid crystal panel,
wherein the photoelectric conversion device is provided between the backlight device and the liquid crystal panel.

15. The liquid crystal display device according to claim 1, wherein the liquid crystal panel is an active matrix type device.

16. An electronic device comprising the liquid crystal display device according to claim 1.

17. The liquid crystal display device according to claim 6, wherein the liquid crystal panel is an active matrix type device.

18. An electronic device comprising the liquid crystal display device according to claim 6.

19. The liquid crystal display device according to claim 11, wherein the liquid crystal panel is an active matrix type device.

20. An electronic device comprising the liquid crystal display device according to claim 11.

21. The liquid crystal display device according to claim 14, wherein the control circuit is included in the liquid crystal panel.

22. The liquid crystal display device according to claim 14, wherein the liquid crystal panel is an active matrix type device.

23. An electronic device comprising the liquid crystal display device according to claim 14.

24. A driving method of a liquid crystal display device which includes a photoelectric conversion device, a liquid crystal panel and a backlight device, the method comprising the steps of:
detecting an external light by the photoelectric conversion device, the external light entering into the liquid crystal display device through the liquid crystal panel; and
controlling a luminance of the backlight device based on the external light detected by the photoelectric conversion device,
wherein the photoelectric conversion device is provided between the backlight device and the liquid crystal panel.

25. A driving method of a liquid crystal display device according to claim 24, the backlight device is turned off during the detecting step.
